(19) United States
(12) Patent Application Publication
(10) Pub. No.: US 2013/0339114 A1
(43) Pub. Date: Dec. 19, 2013

(54) USER DASHBOARD IN AN INTERPERSONAL ELECTRONIC ADVERTISING SYSTEM

(71) Applicant: William J. PLUT, Los Altos, CA (US)

(72) Inventor: William J. PLUT, Los Altos, CA (US)

(73) Assignee: TRUSTEDAD, INC., Menlo Park, CA (US)

(21) Appl. No.: 13/524,948

(22) Filed: Jun. 15, 2012

(51) Int. Cl. G06Q 30/02

(52) U.S. Cl. 705/14.16; 705/14.66

(57) ABSTRACT

An interpersonal electronic advertising system is described. The system is configured to enable an ad suggester to select and send ads for a product or service to an ad recipient. The interpersonal ad can lead to a purchase of the product or the service by the ad recipient and in response the system can compensate the ad suggester. The system can include a dashboard interface allows a user to monitor their system activities. Via the dashboard interface, a user can receive information related to one or more of 1) interpersonal ads sent to ad recipients, 2) interpersonal ads received from other users, 3) earned revenues including revenues derived from sent interpersonal ads and revenues resulting derived from user referrals, 4) their status within the system and 5) a status of each interpersonal ad that they have sent.

### FIELD OF THE INVENTION

This invention generally relates to electronic advertising and digital social sales, and more particularly to systems and methods that allow a user to monitor their activities within an interpersonal electronic advertising system.

### BACKGROUND

Advertising plays a central role in selling numerous products and services. Prior online advertisement providers use automated tools to send an advertisement to a person based on demographic characteristics and past contextual knowledge of the recipient, such as the online traffic content, or using information gathered from Internet searches, email content, or location detection technology.

For a number of reasons, these automated forms of advertisement based on prior online data suffer from a relatively low ratio of conversion into actual purchases. First, online users are inundated with irrelevant advertisements that collectively desensitize a viewer because the advertisements are based on outdated data and no longer relevant to their changing needs. Advertisements frequently show a product that has already been purchased. A person's needs change. For example, if an Internet user builds a car online at a car manufacturer's site, then the person will continue to receive ads for that car, irrespective if they actually liked the car, or whether they found a better car. More importantly, some advertisement providers selfishly display ads according to their highest paying advertiser. This is clearly not in the best interest of a particular ad recipient.

Based on the foregoing, there is a need for systems and methods for improved electronic advertising.

### BRIEF DESCRIPTION OF THE DRAWINGS

FIG. 1 illustrates a system for sending an interpersonal electronic advertisement in accordance with the described embodiments.

FIG. 2 illustrates a flow chart of a method for sending an interpersonal electronic advertisement and attributing compensation in accordance with the described embodiments.

FIG. 3 illustrates a graphical user interface for displaying a viewable page including one or more interpersonal ads in accordance with the described embodiments.

FIG. 4 illustrates a screen layout for a dashboard interface configured to allow a user to monitor their activities in an interpersonal electronic advertising system in accordance with the described embodiments.

FIGS. 5A and 5B illustrate graphical depictions of interpersonal ads that can be displayed in a dashboard interface in accordance with the described embodiments.

FIG. 6 illustrates a user profile that can be displayed in a dashboard interface in accordance with the preferred embodiments.

FIG. 7 illustrates graphical depictions of interpersonal ad related statistics that can be displayed in a dashboard interface in accordance with the preferred embodiments.

FIG. 8 illustrates interpersonal ad related information that can be displayed in a dashboard interface in accordance with the preferred embodiments.

FIG. 9 illustrates referral related information that can be displayed in a dashboard interface in accordance with the preferred embodiments.

FIG. 10 illustrates interpersonal ad status information that can be displayed in a dashboard interface in accordance with the preferred embodiments.

FIG. 11 is a flow chart of a method of generating an interface that allows a user to monitor their activities within the interpersonal electronic advertising system in accordance with the preferred embodiments.

FIG. 12 illustrates a network including an interpersonal electronic advertising system in accordance with the described embodiments.

FIG. 13 illustrates a sample computer system in accordance with the described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As described herein, embodiments of interpersonal electronic advertising methods and systems leverage information about an intended advertisement recipient (or ‘intended recipient’, or ‘ad recipient’, or ‘recipient’) learned by an electronic advertisement suggester (or ‘ad suggester’ or ‘suggester’). For example, a person may tell their co-worker in an email that they need to buy a camera. The interpersonal electronic advertisement system enables the ad suggester to use information about the ad recipient to select and send interpersonal electronic advertisements, or interpersonal ads, to the ad recipient. The system enables the ad suggester to be compensated when the recipient activates the ad.

An activation of the ad can involve the ad recipient completing a purchase associated with the advertisement. For instance, via a user interface, the ad recipient can select an ad created by the ad suggester. The ad can advocate a particular product or service. After selecting the ad, the interface can be reconfigured to allow the ad recipient complete the purchase. After the purchase is completed, the ad suggester can be compensated.

An ad suggester and an ad recipient can have a relationship that involves the sharing of current and trusted consumer information. For instance, the ad recipient may tell the ad suggester that they wish to purchase a particular product or service in the near future. With this knowledge, the ad suggester can use the interpersonal electronic advertising system to send timely and relevant ads to the recipients, which have a high likelihood of action by the recipient. It is believed that in many situations the likelihood of action by the ad recipient, such as purchase resulting from a received ad, will be much higher than current electronic advertising systems. With higher likelihood of action, the ad suggester can be compensated at a much higher rate than current electronic advertising systems afford.

As mentioned in the previous paragraph, via their interpersonal communications an ad suggester within the system can receive consumer information from a potential ad recipient. The ad recipient can use the consumer information as a basis for selecting and sending interpersonal ads to an ad recipient. The interpersonal communications can involve direct, face-to-face communications or electronic methods, such as voice, instant messaging, text, email, or twitter feed, where an electronic device is employed to enable the communication. As an example, in a text or in a face to face conversation an ad recipient can tell the ad suggester that they desire to purchase a product or service in the near future. In other instances, the ad suggester can also obtain consumer information associated with the ad recipient by indirect methods. For example, the ad suggester can obtain consumer information associated with the ad recipient through observation of preferences expressed in previous purchases made by the ad recipient or through the observation of the ad recipient's interaction with other individuals besides the ad suggester. In either case, the ad suggester now has personal and intimate and timely consumer information relating to a consumer need for the ad recipient.

As described above, using consumer information, the ad suggester can use the system described herein to create an interpersonal electronic advertisement for provision to the ad recipient. Creation of an interpersonal ad typically includes a) indication of an ad recipient for the ad, and b) selection or suggestion of a product or service. For example, a man tells his cousin that he is planning a trip and needs to purchase new luggage. This is sufficient information for the cousin to use the interpersonal electronic advertising system to create and send the man an advertisement featuring a particular brand and model of luggage. The cousin may select the particular brand and model based upon additional consumer information the cousin knows about the man, such as how much he typically spend on items, whether he tends to pack a lot, or what type of luggage the man prefers. The man can favorably receive the ad because 1) it arrives from a trusted source with timely knowledge, 2) it is personalized to his preferences and 3) the man is aware the cousin will be compensated if he purchases the luggage via the ad provided through the system.

In contrast, to the system described in the previous paragraph, current context based electronic advertising systems are much more “hit” or “miss.” For instance, the man in the example above might do a search related to their upcoming trip. In response, a context based advertising system might serve up an ad related to travel products. A number of travel product suppliers may bid to have their ad shown first to the man, such as an airline or hotel. If a luggage provider is in the bidding and bids high enough amidst the hundreds of other merchants, then the man may see a luggage advertisement. If the man has not already purchased luggage and the man trusts the source of the ad, then the man may consider selecting the ad and possibly completing a purchase. Thus, in a context based advertising system, the odds of providing a timely and on-point ad to man, such as an ad targeting a desired consumer need of the man that has not already been fulfilled is likely to be much lower than with the systems and methods described herein.

Further, because of the “hit” or “miss” nature of current context based electronic advertising systems, a high proportion of electronic ads displayed to a user of such systems are irrelevant. This conditions the user to generally ignore ads. Thus, the likelihood of acting on future ads is also diminished. It is believed with the interpersonal electronic advertising system described herein ads of a more relevant nature will be delivered more consistently than other electronic advertising systems. This is particularly evident when the interpersonal ad conspicuously displays an ad sender that is known the ad recipient—the recipient is much more responsive to the ad. For example, a man may tune out hundreds of context based electronic ads with no downside; he cannot ignore interpersonal ads created by his wife so easily. Thus, it is believed participants in the interpersonal electronic advertising system will drive much better ad reception, and won't engender as much of the negative conditioning that occurs with other electronic advertising systems.

In some implementations, the interpersonal electronic advertising system can include one or more servers coupled to a network. An ad suggester can access the server via one of their personal electronic devices, such as a home computer or mobile device. The server can be configured to generate an interface for an ad suggester on their device that includes electronic advertisement data. Via the interface, the server is configured to receive electronic advertisement input (or a ‘suggestion’) from the ad suggester to create an ad for an ad recipient. In response to the user input, the server can send an electronic advertisement to the ad recipient.

Via the interpersonal electronic systems described herein, interfaces can be provided where an ad suggester or an ad recipient can view a number of different interpersonal ads. The interpersonal ads viewed by an ad suggester can be sent to various ad recipients. The interpersonal ads viewed by an ad recipient may have been sent from one or more different ad suggesters. In one embodiment, the interface is associated with a social network profile page of an ad suggester. The system can be configured to serve a visitor to the page interpersonal ads selected by the ad suggester specifically for the visitor.

The operator revenues derived from an interpersonal electronic advertising system will generally increase as a number of users utilizing the system increases. Thus, in general, it will be desirable for an operator of the system to increase their user base. A new user can be added via a registration process where the new user provides identification information and is assigned an account. After obtaining an account, the new user can begin creating and sending interpersonal ads to ad recipients which can be users and non-users of the system. Based on the activities of the ad recipients that have received their interpersonal ads, such as purchases, the new user can be attributed compensation. During registration the new user can include payment information, such as bank account information, that allows them to receive the attributed compensation.

To encourage non-users to join the system, interpersonal ads that are sent to non-users can include information that encourages the non-user to join the interpersonal electronic advertising system. For example, when an interpersonal ad is displayed on an electronic device, information encouraging registration with the system, such as a selectable button with the words “register now” can be provided. When the button is selected, a registration process can be initiated. For instance, in response to a selection of the registration button, a web-page with a registration interface can be output to the non-users electronic device. The non-user can use the registration interface to join the interpersonal electronic advertising system.

In another example, the interpersonal electronic advertising system can provide an interface that allows a user to invite a friend to join the system. Via the interface, a user can enter an invitees name and contact information, such an e-mail address, that allows an invite message to be sent to the invitee. The invite message can include a mechanism, such as the selectable button described in the previous paragraph, which can be used to initiate a registration process with the system.

The system can be configured to award compensation to users that personally refer other individuals, such as their friends to register with the system. The compensation of a user that has referred other users to the system can be based upon the activities of the referrals on the system. For instance, in one embodiment, the user can be compensated based upon the total amount purchases that have resulted from interpersonal ads that their referrals have sent using the system.

The interpersonal electronic advertising system can provide an interface, referred to as a dashboard interface, which allows a user to monitor their activities within the system. The dashboard interface can be configured to output one or more of 1) a user profile, 2) parameters that characterize their activities on the system, recent activity including details of interpersonal ads that they have sent, 3) details of their activities in a referral program including progress towards earning rewards, and 4) an ad status associated with each interpersonal ad that the user has previously created. The ad status can indicate the user's progress toward earning a commission from a particular interpersonal ad. In addition, the dashboard interface can display graphical depictions of interpersonal ads that the user has sent to other individuals and/or interpersonal ads that have been sent to the user from other users of the interpersonal electronic advertising system.

The user profile portion of the interface can include information related to the user's effectiveness at suggesting ads, commissions earned, commissions pending, a commission rank that can affect a rate at which a user earns commissions, and links that allow a user to learn additional information about the system or their account. The parameters that characterize their activities on the system portion of the interface can include a number of the interpersonal ads sent, a number of interpersonal ads sent resulting in purchases and revenues derived from the sending of the interpersonal ads. The recent activity portion of the interface can include details of interpersonal ads they have recently, such as information about the ad recipient and the product or service in the sent interpersonal ads.

The referral portion of the interface can include details of their activities in the referral rewards program, such as information about how rewards are earned in the referral rewards program and their progress towards earning rewards. The ad status portion of the interface can include information associated with each interpersonal ad previously created and sent. For example, information in the ad status section can include one or more of i) an identity of the ad recipient, ii) the product or service described in the ad, iii) whether a purchase has been made from the interpersonal ad, iv) potential compensation earned from a purchase, v) a destination for the compensation, such as a user account or a third-party account or vi) combinations thereof.

One aspect of the embodiments described herein can be generally characterized as a method in an interpersonal electronic advertising system. The method can include 1) generating in a processor a user account associated with a user; 2) generating in the processor a plurality of interpersonal ads associated with the user account wherein contents and an ad recipient for each interpersonal ad are input by the user; 3) receiving in the processor a request to generate a dashboard interface associated with the user account wherein information associated with the plurality of interpersonal ads is output via the dashboard interface; 4) in response to the request, retrieving in the processor information associated with the plurality of interpersonal ads; and 5) generating the dashboard interface using the retrieved information.

Techniques and methods described herein can find use with a wide array of electronics devices. For example, desktop and laptop computers are now common and may implement software that permits users to select and send and receive ads. Electronic interpersonal advertising as described herein is also suitable for use with mobile electronic devices such as personal digital assistants (PDAs), cellular telephones, smartphones, portable computer systems, thin clients, portable tablet computers, audio players, among others, because of the inherent portability of such devices.

All or portions of the subject invention may be implemented as a method, apparatus, system or article of manufacture using programming and engineering techniques to produce software, firmware, hardware or any combination thereof to control an electronic device to implement the present invention. The term “article of manufacture” as used herein is intended to encompass a computer program with executable instructions accessible from any computer readable device, carrier, or media. For example, computer readable media can include but is not limited to magnetic storage devices, optical disks, smart cards, flash memory devices among others. Of course, those skilled in the art will recognize many modifications may be made to this configuration without departing from the scope or spirit of the disclosed invention.

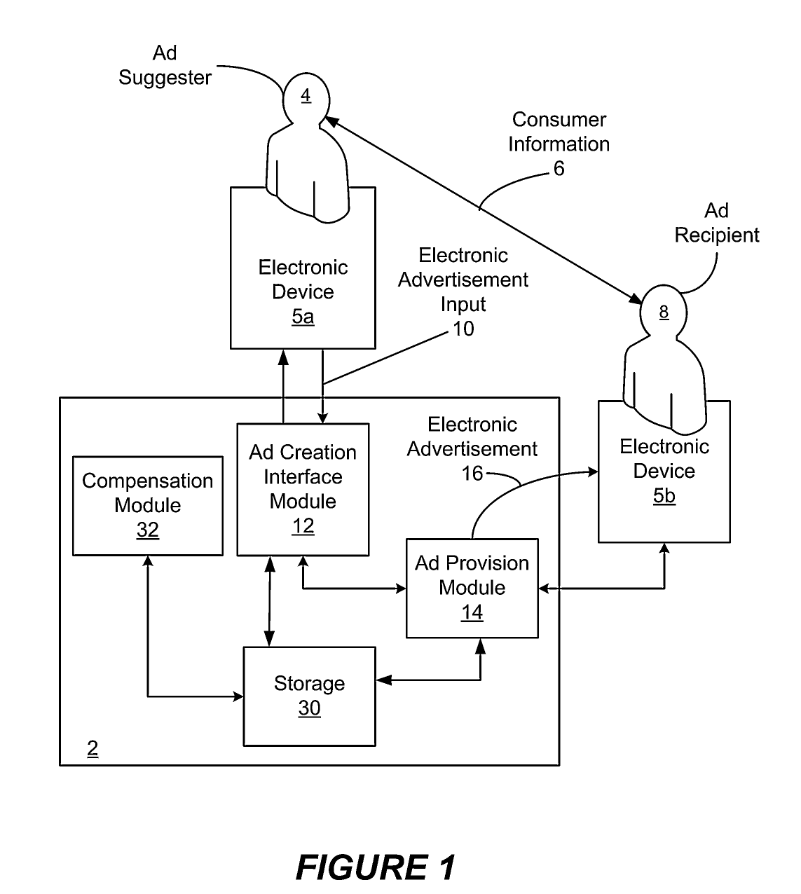

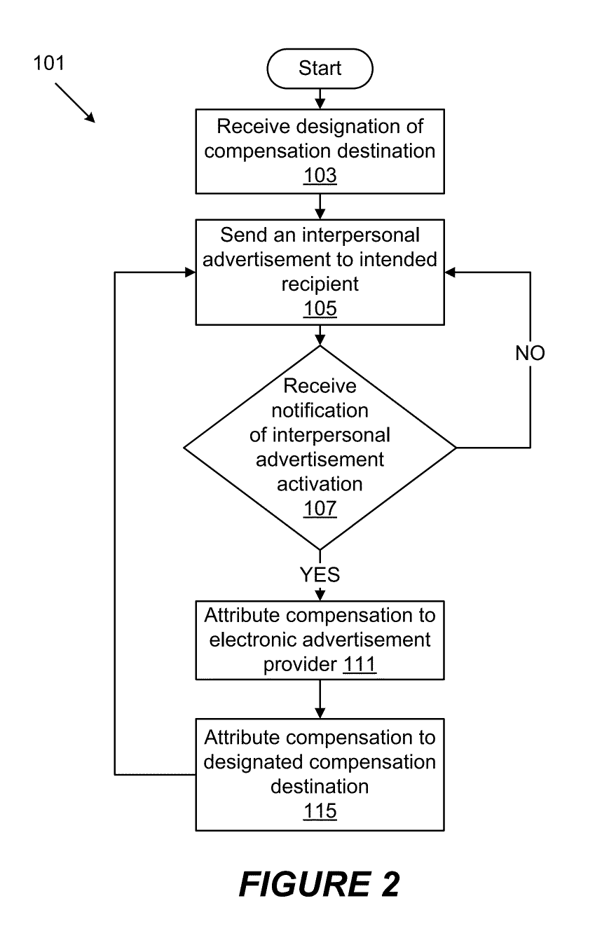

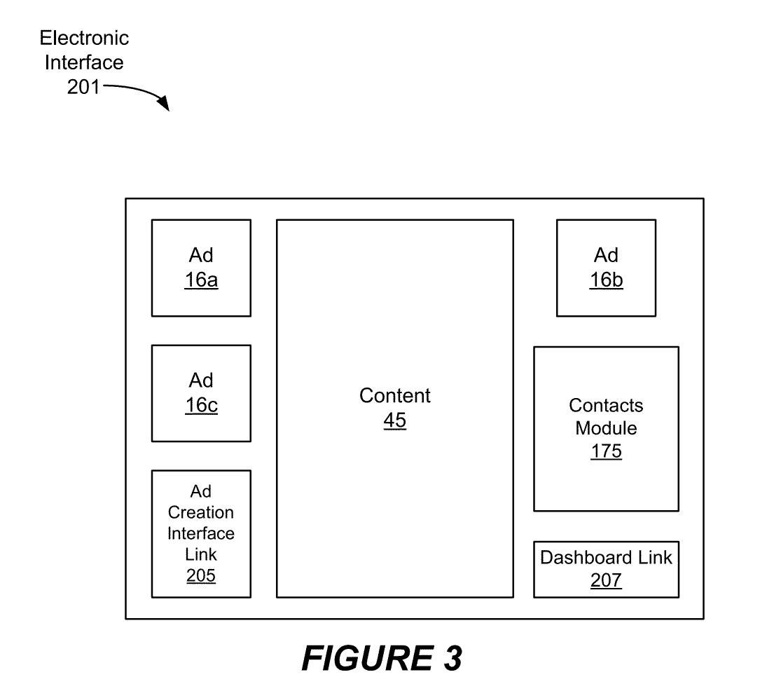

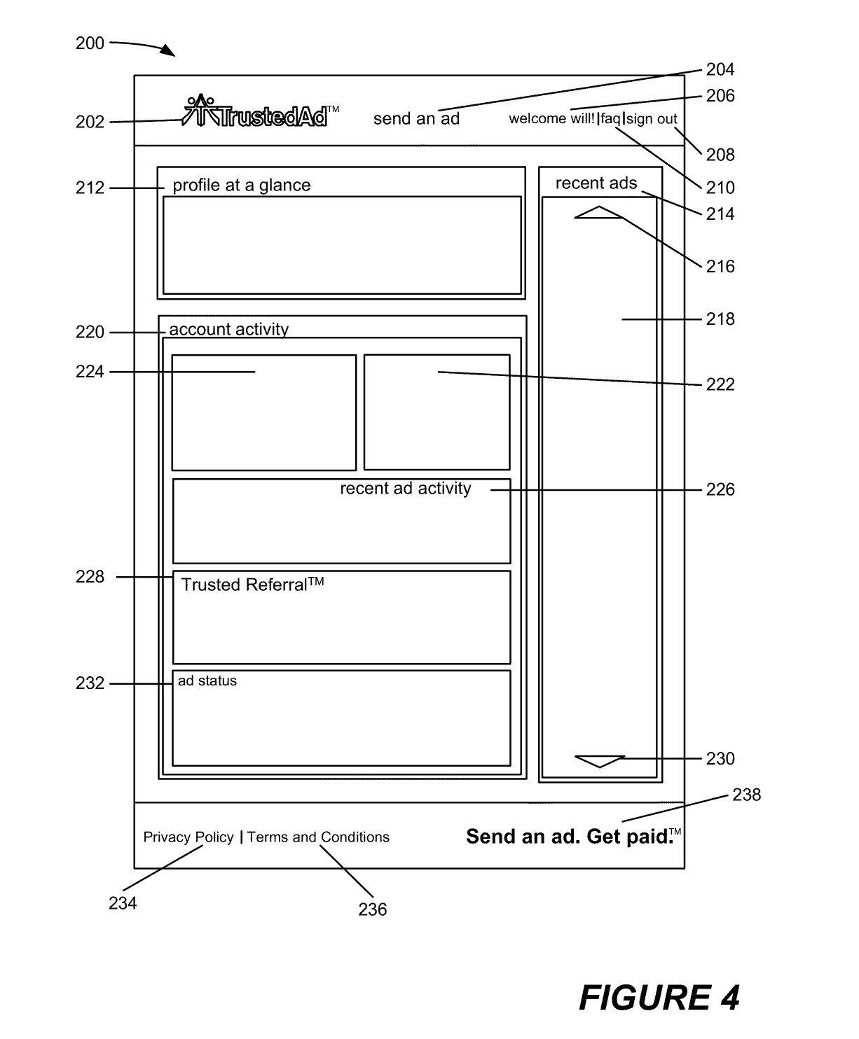

An interpersonal electronic system including a dashboard interface that allows a user to monitor their activities within the system is described with respect to the following figures and sections. An overview of the interpersonal advertising system is described with respect to FIGS. 1 and 2. In particular, consumer information, creating and sending interpersonal ads based upon the consumer information and compensation for sending interpersonal ads that result in a purchase by an ad recipient are described. In addition, methods for determining for an ad suggester various ad suggestion effectiveness metrics are described. With respect to FIG. 3, one example of an interface that allows an ad recipient to view interpersonal ads is described. A page layout for a dashboard interface is discussed with respect to FIG. 4.

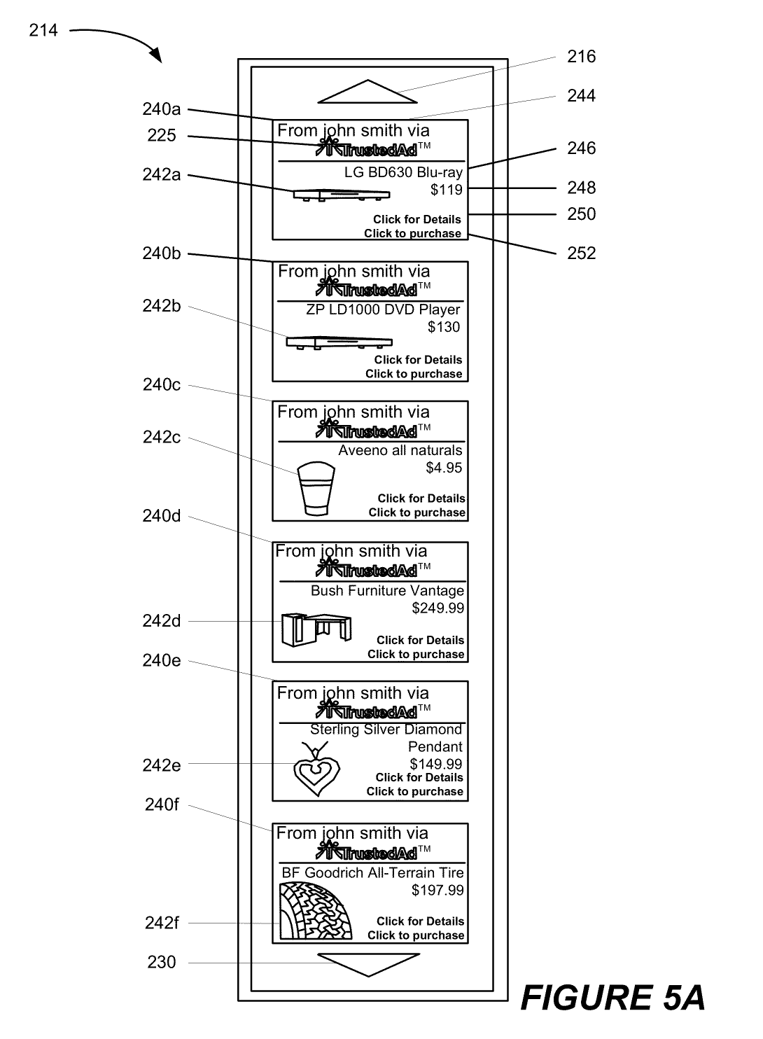

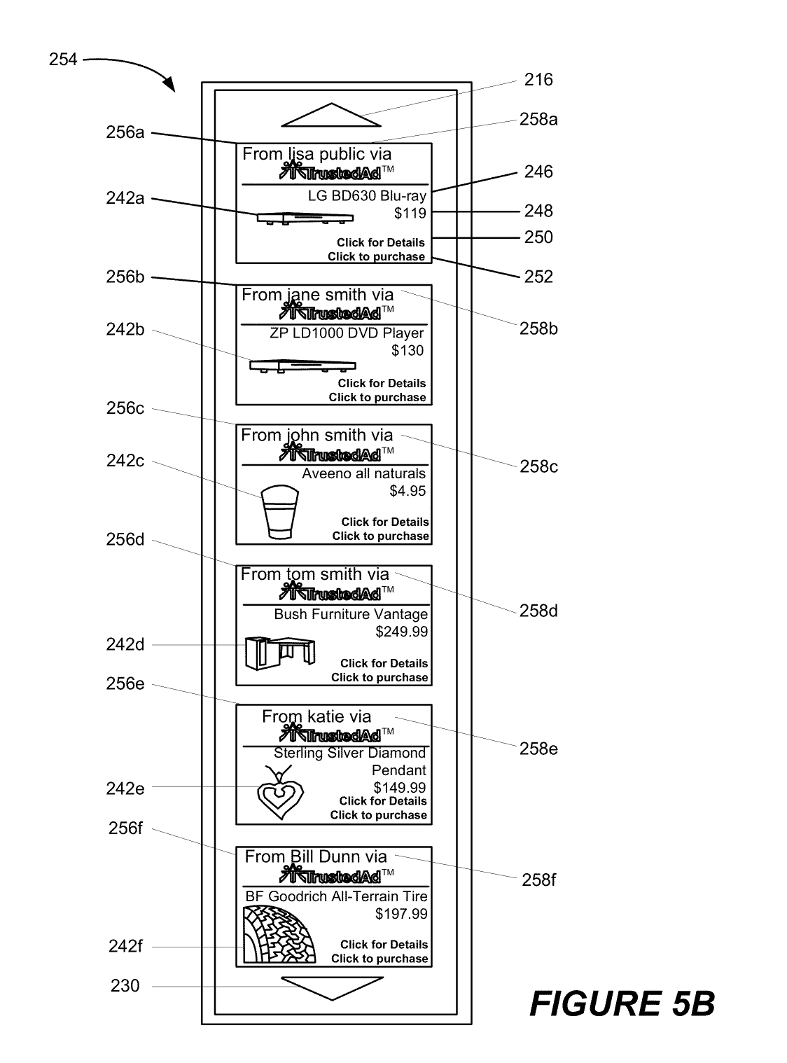

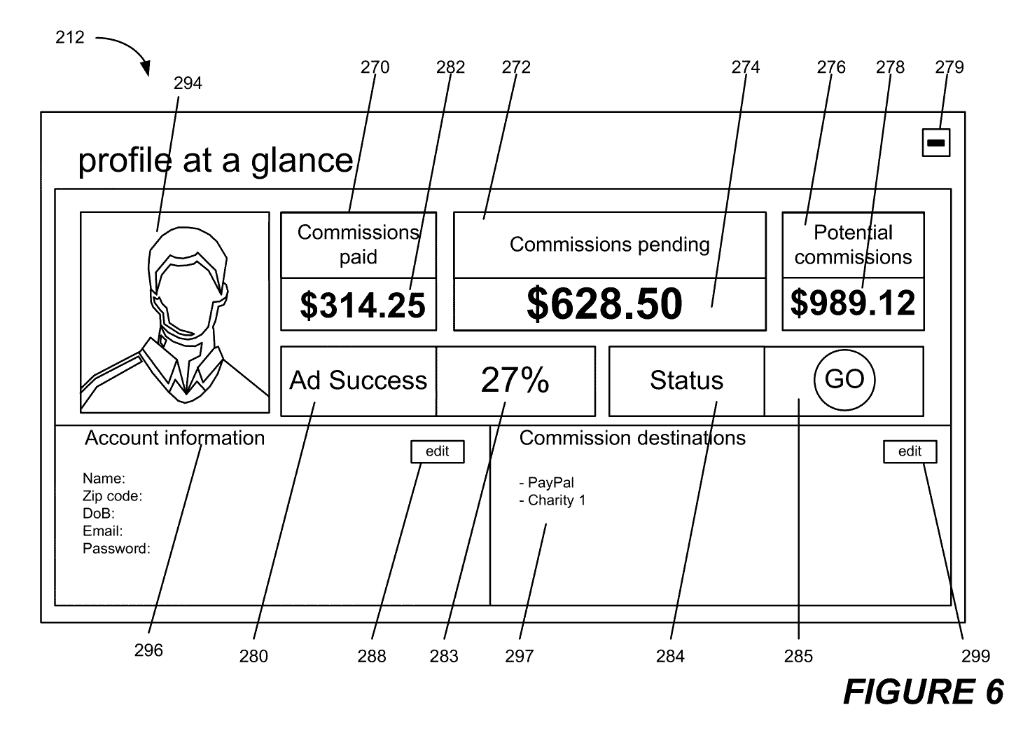

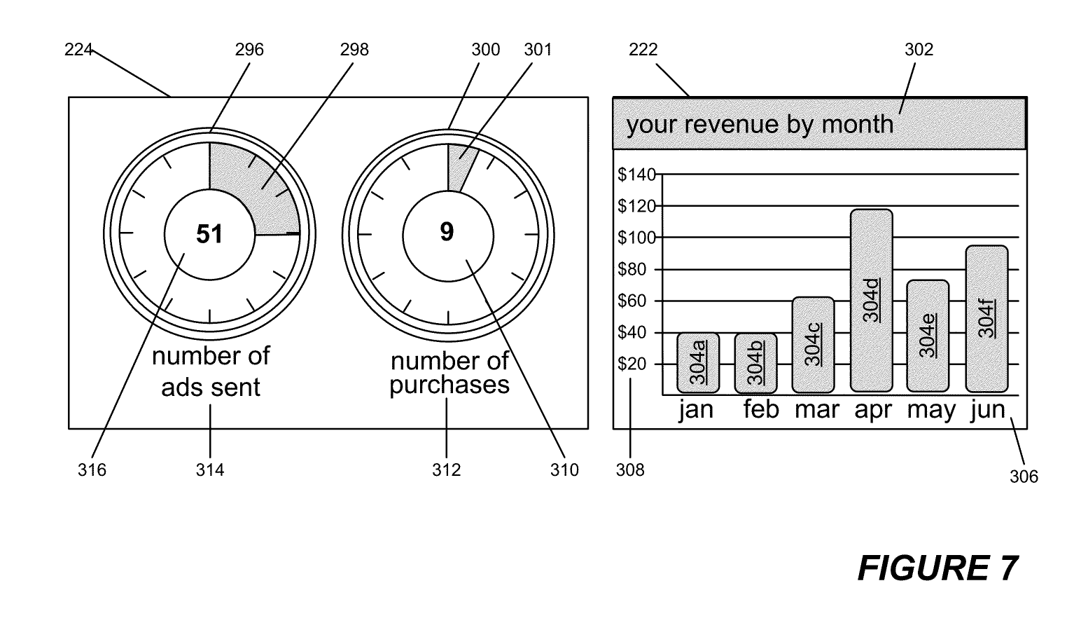

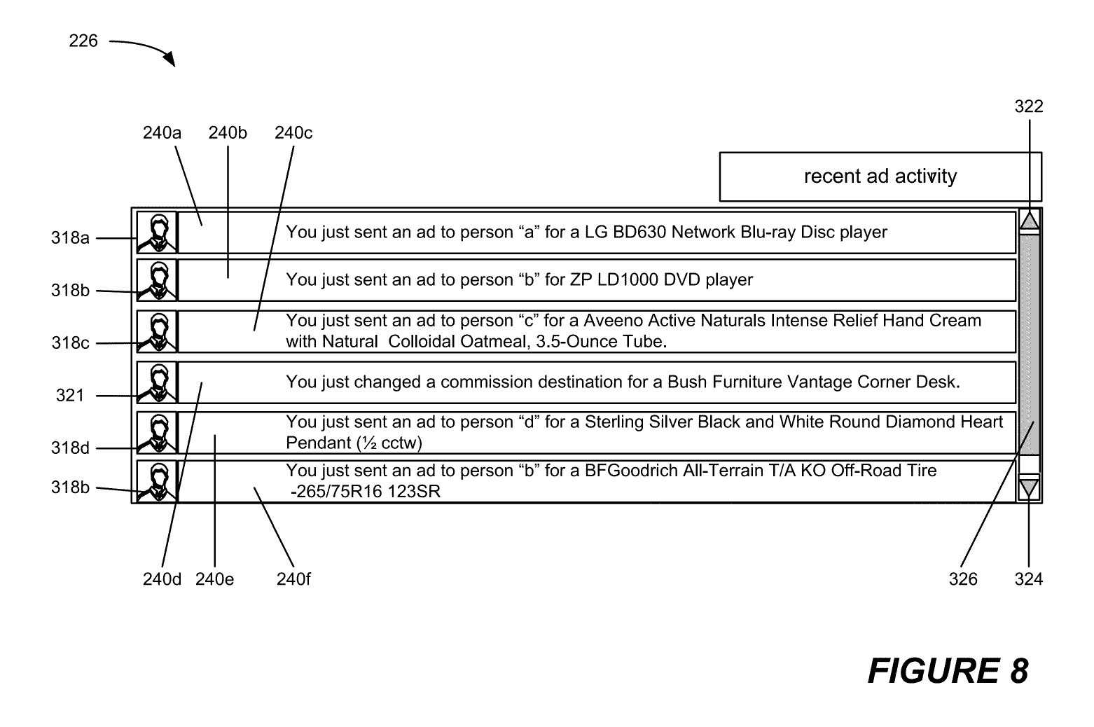

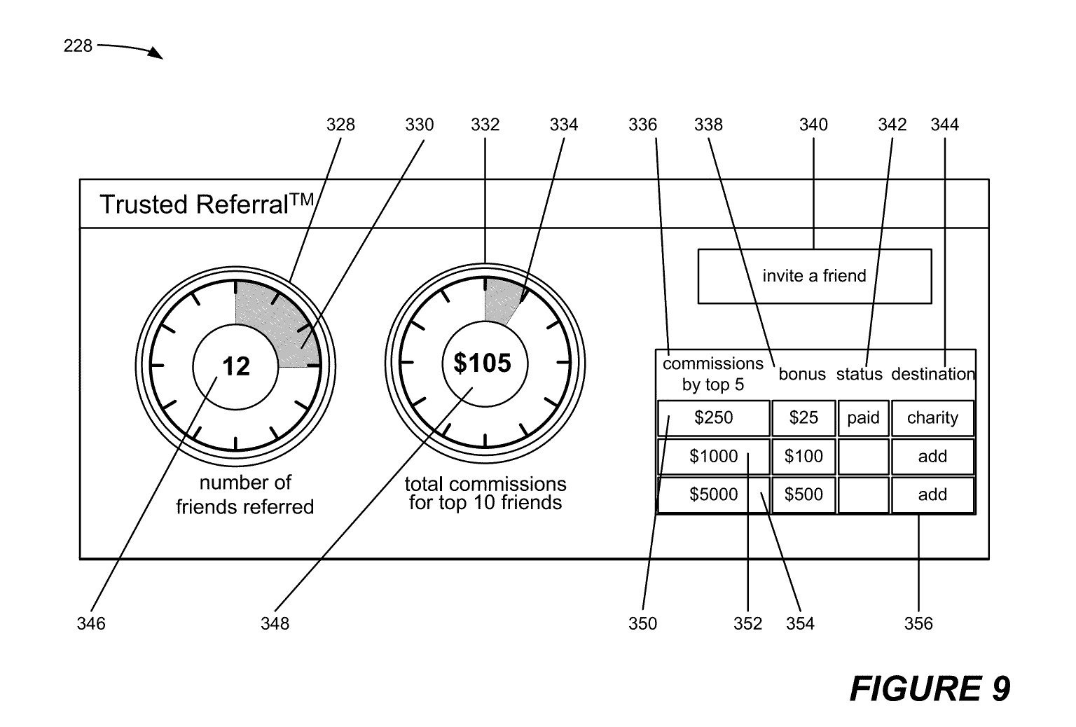

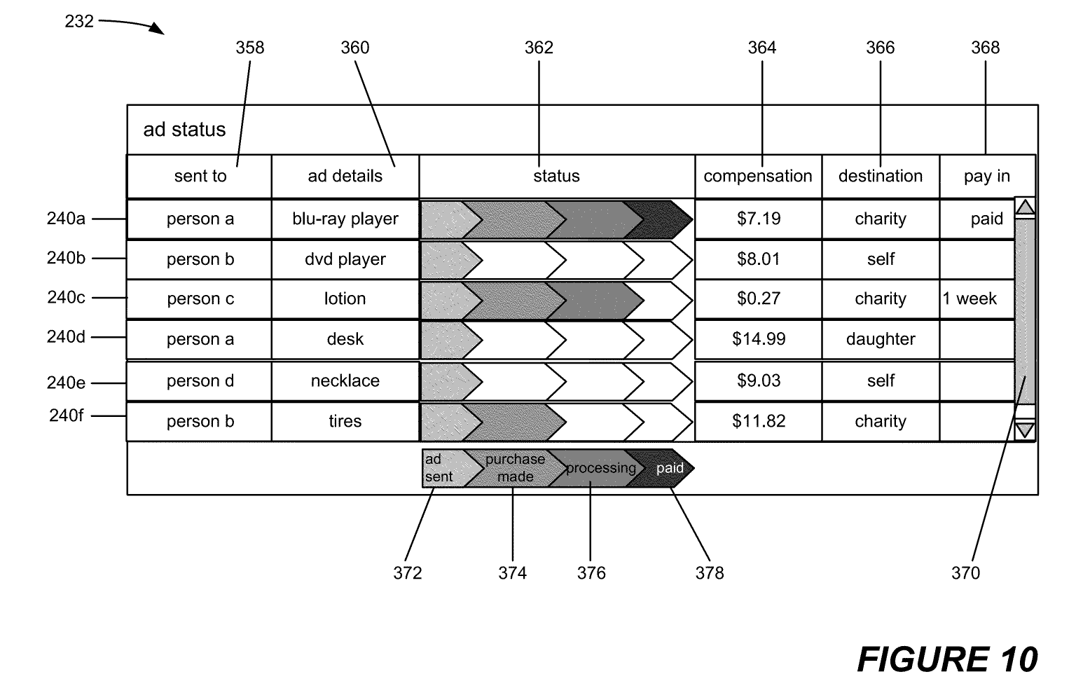

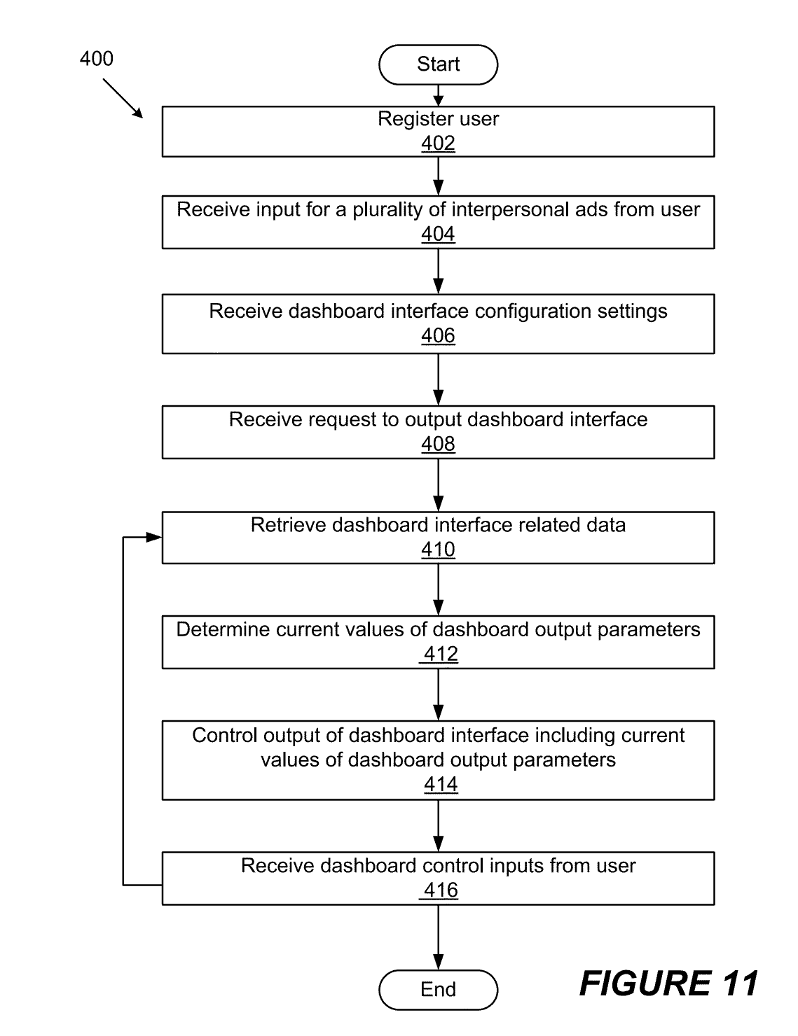

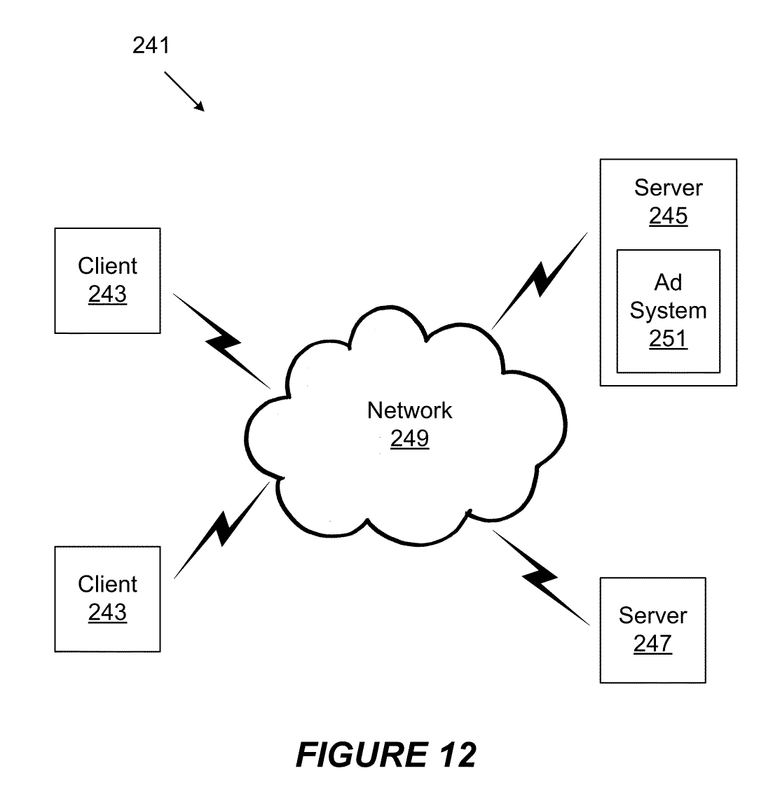

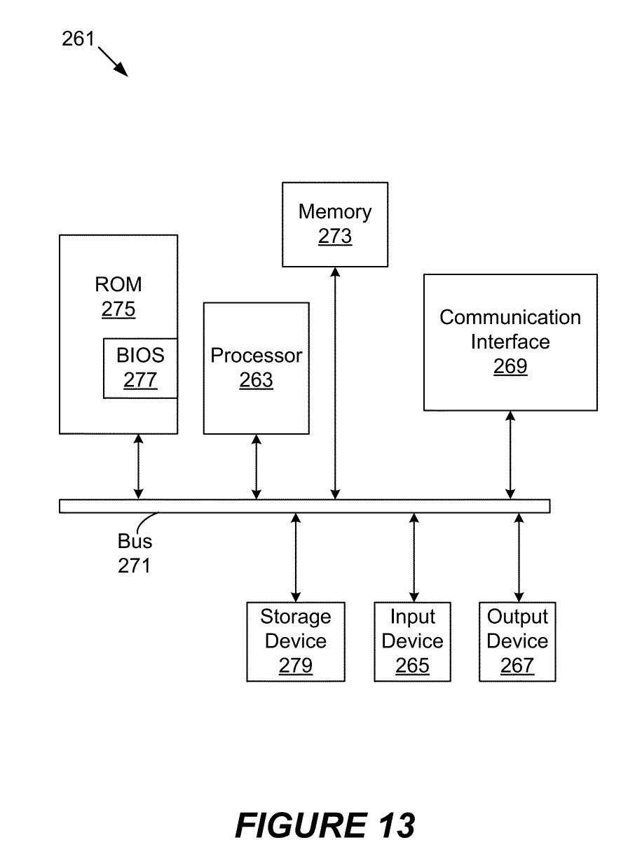

Graphical depictions of interpersonal ads that can be output via the dashboard interface are described with respect to FIGS. 5A and 5B. The interpersonal ads can have been sent by the user (FIG. 5A) or received from other users (FIG. 5B). With respect to FIG. 6, a portion of the interface for depicting a user profile within the system is discussed. A portion of the interface for displaying statistics related to interpersonal ads is described with respect to FIG. 7. With respect to FIG. 8, a portion of the interface for depicting details of interpersonal ads that have been sent is discussed. A portion of the interface for communicating information about a referral rewards programs is described with respect to FIG. 9. In regards to FIG. 10, a portion of the interface for displaying ad status information is discussed. With respect to FIG. 11, a method of generating a dashboard interface in an interpersonal electronic advertising system is described. Finally, system and system components that can be utilized in an interpersonal electronic advertising system are described with respect to FIGS. 12 and 13.

### Interpersonal Electronic Advertising System

FIG. 1 illustrates a system 2 for sending interpersonal electronic advertisements in accordance with one embodiment. System 2 includes an interpersonal advertisement creation interface module 12, ad provision module 14, storage 30 and compensation module 32. The system 2 can be configured to interact with numerous electronic devices, such as 5a and 5b. In the example in FIG. 1, electronic device 5a is controlled by an ad suggester 4 and electronic device 5b is controlled by an ad recipient 8.

As described in more detail below, the ad creation interface module 12 can relate to system components that allow an ad suggester to create or suggest an interpersonal advertisement. Whereas, the interpersonal advertisement provision module 14, or ad provision module 14 can refer to any device, system or tool within system 2 configured to send ad 16 to intended recipient 8. Data storage 30 can include hardware and/or software for storing information related to system 2. Typically, when the ad suggester 4 creates and sends an ad that leads to a purchase by the ad recipient, compensation is attributed to the ad suggester 4. Compensation module 32 can be configured to attribute an incentive or compensation within interpersonal advertising system. Compensation can refer to any type of incentive, whether monetary, or in another form such as a discount on a present or future consumer transaction, coupon, merchandise, award, products, services, electronic tokens, virtual currency, rebate, among others.

During operation, the system 2 can be configured to interact with a various number of electronic devices where the number of electronic device interacting with the system can vary over time. The system 2 can provide different functions to each of the electronic devices and the functions provided to each device can change over time. For instance, at a first time, individual 8 can engage with system 2 as an ad recipient via device 5b. At a later time, individual 8 can engage with the system 2 as an ad suggester via device 5b. In FIG. 1, for the purposes of illustration, individual 4 is referred to as ad suggester 4 and individual 8 is referred to as an ad recipient 8. However, as noted, at different times the ad suggester 4 can engage system 2 in the role of an ad recipient and the ad recipient 8 can engage the system 2 as an ad suggester.

The system 2 can be configured to establish communication connections with electronic devices, such as 5a and 5b. Via the communication connections, information can be exchanged between the electronic devices and system 2. For example, via device 5a, ad suggester 4 can select and transmit electronic advertisement input 10 to system 2. Further, an ad recipient 8 can view an electronic advertisement 16 suggested by the ad suggester 4 which the system 2 has routed such that it can be viewed on device 5b.

In description to follow, an electronic advertisement suggester 4 (also referred to herein as ad suggester 4, or suggester 4) can refer to any person that possesses consumer information 6 regarding an intended ad recipient 8. Whereas, intended electronic advertisement recipient 8 (also referred to herein as intended recipient 8, or intended electronic advertisement recipient 8, or intended ad recipient 8, or recipient 8) can refer to an intended recipient of an interpersonal (or ‘suggested’) electronic advertisement generated on system 2, such as 16. The advertisement suggester 4 can interact with the system 2 via a client device, such as device 5a to select an ad, such as 16, intended for receipt by the ad recipient 8. Thus, the selected ads are interpersonal ads for the intended ad recipient 8 by the ad suggester 4. Ads selected in this manner are referred to as interpersonal ads.

The ad recipient 8 can interact with the system 2 via client device, such as device 5b, to receive interpersonal electronic advertisements created by the ad suggester 4, such as ad 16. Suitable electronic devices that can be utilized by the ad recipient 4 or the ad suggester 8 can use to interact with system 2 include: a portable phone and/or phone number, a mobile device, a tablet, a thin client, a laptop computer, a netbook computer, a portable music player, a television, a cable display device, a desktop computer or any other electronic device configured to send and receive electronic transmissions or communications.

Data storage 30 can include hardware and/or software for storing information related to system 2. Data storage 30 can store information relating to the suggestion or provision of electronic advertisements. In specific embodiments, data storage 30 can include information relating to one or more of: a) a listing of advertisements 16, b) an entity that is related to each advertisement, c) suggesters 4, d) intended recipients 8, e) advertisement creation interface module 12, f) advertisement provision module 14, g) pointers to other websites or data locations that have products or advertisements, h) electronic advertisement input 10 and combinations thereof. Data storage 30 may include a database, a table, local hard disk memory, one or more RAM devices, memory available with conventional cloud computing techniques, or any means for storing information. In a specific embodiment, data storage 30 uses a relational database such those provided by Oracle Corporation of Redwood City, Calif. In another specific embodiment, data storage 30 employs an online database service, or Database-as-a-Service, (DaaS), such as those available from Microsoft Corporation of Redmond, Wash., or Amazon.com, Inc. of Seattle, Wash.

Within the system 2, the activities of both the ad suggester 4 and the ad recipient 8 can be tracked. In some instances, users of the system can be assigned one or more digital identifiers and the tracked activities can be associated with these one or more digital identifiers. In some embodiments, the system 2 can be configured receive information, such as a login and a password, that allow a user's identity to be verified and digital identifiers associated with the user to be located. After verification, activities performed by the user can be tracked and associated with their digital identifiers. Tracking information gathered by the system 2 can be stored to storage 30.

In one embodiment, the system 2 can store device information that is associated with an individual, such as the ad suggester 4 or the ad recipient 8 to storage 30. The device information can be associated with the individual when the individual regularly controls the device to interact with the system 2. Thus, when the device information for a particular device is detected, the system 2 can be configured to determine whether the device is associated with a particular individual. When the device is determined to be associated with a particular individual, activities performed using the device, such as 5a or 5b, can be associated with the individual. For instances, ad suggester 4 can register information about device 5a with the system 5a. When the system 2 detects device 5a, such as when a communication session is initiated with the device, the system 2 can determine device 5a is associated with ad suggester 4. Then, the system can be configured to attribute subsequent activities involving the system 2, such as an ad selection performed via device 5a, to ad suggester 4, or an ad view or activation for recipient 8.

In particular embodiments, portions of the system 2 can be embedded in other systems. For instance, an ad creation interface module 12 can be integrated into a social media platform where the module 12 communicates with a remote ad provision module 14 in system 2 to provision ads to ad recipients. In this example, system 2 might also include its own ad creation interface module 12 separate from the embedded ad provision module. In another example, all the components of system 2 can be embedded in another system, such as a system associated with a social media platform. Many such configurations are possible and the example in FIG. 1 is shown for the purposes of illustration only. Further, functions attributed to each module can be combined or broken out in different manners and then the abstraction shown in FIG. 1 which is provided for the purposes of illustration only.

### Consumer Information in an Interpersonal Electronic Advertising System

As described above, an ad suggester, such as 4, can receive consumer information 6 from an intended ad recipient 8. As the term is used herein, consumer information 6 can refer to information relating to but not limited to a shopping need, recipient desire, a potential purchase, a recipient preference, an upcoming event associated with the recipient or a current or future location of the recipient. Examples of consumer information 6 include but are not limited to a) a product or service, b) price information, c) location information for recipient 8 or a store offering a product or service of potential worth to recipient 8, d) personal information related to a purchase such as a time or place of purchase, e) specific or approximate or general product and/or service information, etc. In a specific example, ad suggester 4 has knowledge that a friend recently purchased a house and wants to purchase a garage door opener that fits a garage door in the house. Consumer information 6 in this instance can include the knowledge of the friend's recent house acquisition, their desire to purchase a garage door opener for his garage door, and maybe specifics on the garage door or when the recipient intends to purchase the garage door opener.

Consumer information 6 can be received directly or indirectly. The direct or in-direct communications of consumer information from recipient 8 to ad suggester 4 can involve non-electronic methods, electronic mechanisms, and combinations thereof. Non-electronic methods can include but are not limited to face to face conversations, a written note or observations of past purchases made by the recipient 8. A face to face conversation between the ad suggester 4 and the ad recipient 8 can result in a direct transmission of consumer information 6. Whereas, the ad suggester 4 can observe past purchases made by the ad recipient 8 to obtain consumer information 6.

Electronic mechanisms suitable for use herein, such as for a transmission of consumer information 6, can include a voice conservation enabled by an electronic device, an electronic message such as a text message or email from intended recipient 8 to suggester 4, a twitter feed from intended recipient 8 to suggester 4, one or more portions of an online chat conversation, one or more social networking posts, among others. For each of the electronic examples, an electronic device, such as a server, typically relays the consumer information 6 between the recipient 8 and suggester 4, and transmits the consumer information 6 to suggester 4. A direction electronic communication of consumer information 6 from ad recipient 8 to ad suggester 4 might involve the ad recipient 8 expressing a desire to purchase an item in a text message. An indirect electronic communication of consumer information 4 might involve ad recipient 8 posting a consumer need to person different from the ad suggester 4 and the ad suggester 4 viewing the post to obtain the consumer information 6.

As shown in FIG. 1, the transmission of consumer information 6 can occur via a communication channel outside of system 2. For instance, electronic device 5a and electronic 5b can enable voice communications between the ad suggester 4 and ad recipient 8 where the communications take place outside of system 2. In other embodiments, the system 2 can be configured with communication functions. For instance, system 2 can provide a chat function that allows the ad suggester 4 and the ad recipient to communicate and transfer consumer information 6. Thus, in some embodiments, although not shown, the consumer information 6 can be routed through system 2.

In more detail, as noted above, the ad suggester 4 can directly or indirectly receive consumer information 6 from the ad recipient 8. Indirect methods can involve observations that occur during the interactions or visits to the places where recipient lives or works. For instance, an ad suggester, such as 4, may notice that an ad recipient, such as 8, uses a particular product, such as a particular brand of shoes or a brand of a purse. Later, the ad suggester 4 may learn via a face-to-face conversation that the intended recipient is looking for a new purse or shoes. Based upon the consumer information they have indirectly learned, i.e., the ad recipient 8 may have never told the ad suggester 6 directly about the brand of purse they prefer, and the consumer information they have directly learned, the ad suggester 4 may select an ad for the ad recipient 8 via system 2.

As another example, an ad suggester 4 can obtain consumer information 6 when the ad suggester visits the ad recipient's 8 home. The recipient 8 may not even be present. While visiting, the ad suggester 4 may notice things about certain purchases the ad recipient 8 has made in the past. The observations the ad suggester 4 has made may later server as consumer information 6 when the ad suggester 4 is selecting an ad, such as 16, for the ad recipient 8. In yet another example, the ad suggester 4 can overhear a conversation the ad recipient 8 is having with another individual (e.g., the ad suggester 4 and ad recipient 8 can live together with other individuals) and learn consumer information 6. Thus, through interactions that occur over time, an ad suggester 4 can be directly or indirectly gathering consumer information 6 from the ad recipient 8.

In other embodiments, consumer information 6 can relate to third-parties, such as individuals or groups known by the ad suggester 4 or ad recipient 8. For instance, if the ad recipient 8 is intending to purchase an item for another individual, consumer information 6 can include information about the individual that is to receive the purchase and/or information about the ad recipient 8. If the ad recipient 8 is intending to purchase an item for a group, the consumer information 6 can include information that the ad suggester 4 knows about the group and/or ad recipient 8.

In a father/son jewelry example, a son (ad suggester 4) can have knowledge that his father (ad recipient 8) has not purchased an anniversary present for the son's mother (third party, not shown). Consumer information 6 that the son possesses may include one or more of: i) information about an upcoming wedding anniversary, ii) specific jewelry product information that mother prefers, iii) the father's current location, iv) an anticipated price range, v) that father wants to do something nice for his mother, such as buy her jewelry, vi) other types of gifts the father has bought the mother on similar occasions or vii) combinations thereof. Thus, in this example, the consumer information 6 known by the ad suggester 4 (son) is related to the ad recipient 8 (father) and additionally a third-party (mother).

As described above, a relationship between suggester 4 and intended recipient 8 can improve intended recipient's 8 reception of advertisement 16. Depending on the relationship between 4 and 8, the intended recipient may activate ads, such as 16, at a higher rate as compared to ads received from other individuals or ads generated from context-based electronic advertising systems. After the ad recipient receives an ad from the ad suggester 4, activation of the ad can involve the ad recipient using system 2 to view the ad 16, select the ad 16, or purchase a product or service based on ad 16. As is discussed more below, the purchase of a product or service based on ad 16 can result in compensation for ad suggester 4 via compensation module 32.

In more detail, a perception of trustworthiness can exist between the two people interacting with system 2, such as 4 and 8. When the person 8 knows that certain consumer information 6 was given to suggester 4 in a trusted communication, person 8 then may expect ad 16, or welcomes the ad based on its source. An ad provided to ad recipient in this manner may be much better received than an ad, such as 16, from a non-trusted source, such as a business that the person 8 has no history of prior interaction, knows very little about the person 8 and has paid a search service the most money for an ad spot. Systems and methods described herein however enable intended recipient 8 to receive an electronic advertisement 16 from a known suggester 4. It is believed that factors, such as the trust between the ad recipient 8 and ad suggester 4 and consumer information 6 possessed by the ad suggester 4 that was ideally used in selecting an ad for the recipient 8, increase the likelihood that intended recipient 8 views and acts on the advertisement 16 when system 2 is employed.

The system 2 can be configured to receive electronic advertisement input generated on an electronic device, such as 5a. An interface, such as an interface implemented via a web-browser or a client application executing on the electronic device can be used to provide the electronic advertisement input 10 to system 2. In one embodiment, the ad creation interface module 12 can be configured to generate an interface on an external electronic device, such as 2, via a client application such as a web-browser. The electronic advertisement input 10 can include data related to an ad recipient 8, such as information that allows an interpersonal ad to be sent to the person, consumer information 6, and/or advertisement selection received by ad creation interface. The ad suggester 4 may use the interface to locate an ad associated with a particular product or service provider accessible on system 2. Thus, electronic advertisement input 10 can include information related to one or more of a company, a person, an entity, a vendor, a product, or a service.

The consumer information 6 can be reflected in a selection of an interpersonal advertisement within the system. In addition, the system may allow a user, such as 4, to store consumer information 6 associated with particular individuals, such as anniversaries and product preferences. In one embodiment, this information can be stored in storage 30. Consumer information 6 entered as electronic advertisement input 10 can be stored and later retrieved when the ad suggester 4 subsequently interacts with the system 2.

### Ad Creation and Ad Provisioning in an Interpersonal Electronic Advertising System

As described above, the ad creation interface module 12 can support a GUI that allows suggester 4 to create an ad using their consumer information 6. The GUI can be configured to allow the user to view and select various ads that can be sent to the ad recipient 8. Businesses associated with these ads can have agreed to send compensation to system 2 when an ad from system 2 has resulted in a purchase. In one embodiment, the system 2 can be configured to notify a business when an ad associated with the business has been created by an ad suggester 4 for an ad recipient 8. The notification message can include information that identifies the ad as having been created using system 2. This information may allow the business to keep track of potential transactions that can result in compensation being sent to system 2.

In a specific example of involving the utilization of system 2, a son 4 can possess consumer information 6 that his father 8 wants to purchase jewelry for a wedding anniversary 6. The son 4 can establish a communication with system 2 via electronic device, such as 5a, after which an interface associated with system 2 can be generated on device 5a. As described above, the ad creation interface module 12 can support the generated interface. The ad creation interface module 12 can be configured to support an interface that is suitable to the type of electronic device 5a that is being utilized. For instance, a different interface with different capabilities can be provided for a smart phone as compared to a laptop computer.

Via the generated interface, the son 4 can create, select and/or send one or more ads 16 for the father 8 indicative of his consumer information 6. In addition, via the interface, the son 4 may enter consumer information 6, such as the father's anniversary. The system 2 can be configured to store this information and possibly later remind the ad suggester 4 of this upcoming event.

Besides sending the ad 16 directly to the father, other modes of allowing the father to view the ad are contemplated. In one embodiment, the system 2 can be configured to interact with a social media application that displays the son's profile page. The system 2 can be configured to display interpersonal ads to the son's profile page. When the father visits the sons profile page, the interpersonal ad 16 can be displayed to the father. In this manner, the father may learn about the detail. Further details of social media applications are described below with respect to FIG. 3.

After the ad 16 is sent and if the father 8 acts upon the ad 16, the system 2 can be configured (see FIG. 2) to allow the son 4 to be compensated directly or indirectly from a merchant or service provider where the father 8 made a purchase. The compensation module 32 can be configured to perform this function. As an example, a jewelry store associated with ad 16 can agree to pay a percentage of the purchase generated from ad 16 to system 2, such as 10% of the purchase. After receiving the money from the jewelry store, the son can be paid some portion of the money to the son. The participating store is will to pay such advertising fees since, without the son's help and timely advertising input 10, the store might not have made this particular sale to the father 8. If it is determined the father 8 was drawn to the store as a result of receiving the ad 16, in some embodiments, the ad suggester 4 can be compensated in some manner even if a purchase isn't made. Compensation of ad suggester 8 is described in further detail below.

As described above, an interface supported and/or generated by module 12 can receive electronic advertisement input 10 entered by ad suggester 4. Again, suggesting an ad can refer to the process of providing input 10 that at least partially determines ad 16 including receiving specific input that leads to the selection of a specific ad 16. Using ad creation interface module 12, suggester 4 can provide input 10 that may include or more of: i) information related to the results from searching for an ad related to consumer information 6, ii) information related to the selection of an ad 16 from a list, ii) information related to identification of one or more recipients 8 for ad 16, iv) information related to entering key words and selecting input 10 or the ad 16 based on results provided in response by ad creation interface module 12 or v) combinations thereof. Suitable interface components to enable an ad suggestion by person 4 can include but are not limited to one or more of a: drop down box, search box, a scroll down bar, tool bar buttons, menus, text boxes that accept user input, check boxes and the like. In one embodiment, the interface components can be formulated as a GUI for output to an electronic device, such as 5a or 5b. These interface components can allow suggester 4 to suggest or specifically select one or more electronic advertisements, such as 16, from a set of advertisements available on system 2. Further, the interface component components can allow an ad suggester to view their progress related to suggesting ads, such as whether interpersonal ads that they previously sent have resulted in a purchase and associated compensation.

The advertisement provision module 14, or ad provision module 14 can refer to any device, system or tool within system 2 configured to send interpersonal ad 16 to intended recipient 8. Ad provision module 14 is communicatively connected to ad creation interface module 12 and can be configured to receive data representing or at least partially identifying ad 16 from ad creation interface module 12. Ad provision module 14 sends data that allows intended recipient 8 to view the advertisement 16 created by the suggester 4 in an electronic format. In general, ad provision module 14 sends any suitable data for displaying, representing, identifying, rendering or outputting an ad 16 on a device 8. In a specific embodiment, ad provision module 14 sends a jpeg image or other suitable graphics format for the ad 16 when the ad includes graphics data for display on an electronic device, such as 5b. In another embodiment, the ad provision module can send audio files that allow an audio description of the ad to be output.

In one embodiment, the electronic advertisement suggester selects a specific ad via the interface generated by ad creation interface module 12, inputs contact information for recipient 8, and ad provision module 14 relays this ad to the recipient 8. In another embodiment, suggester 4 inputs contact information for recipient 8 but only suggests a general advertisement or topic related to the ad 16 that is eventually sent to the recipient 8. In this case, the suggester does not provide input that identifies a specific ad, but provides non-specific criteria that relates to a set of advertisements that fit the non-specific criteria. The advertisement input 10 in this case includes insufficient detail to identify an ad that will be sent. Instead, the non-specific input results in a set of advertisements that fit the non-specific criteria. This leaves ad provision module 14 to select a specific advertisement 16 that will be sent to the recipient. In this instance, the consumer information 10 provided by the ad suggester 4 allows the system 2 to act as an ad suggester.

It should also be appreciated that an ad selected by suggester 4 may not be the same advertisement 16 received by recipient 8. For instance if the ad has expired since it was created, the system can select a similar or related ad to send to the recipient 8. In one embodiment, if an interpersonal ad, such as 16, a specific deal and deal expires before the ad is converted, the system 2 can be configured to notify the ad suggester 4 that the interpersonal ad is no longer valid and/or notify the ad created of a related ad that is valid and can be selected.

An electronic advertisement 16 that is sent via system 2 can convey any commercial opportunity to recipient 8 or other message for a potential consumer transaction. Electronic advertisement 16 can include any format or data suitable for conveying the commercial opportunity to an ad recipient. The advertisement 16 can include one or more of video data, audio data, text, graphics information, or any combination thereof. Electronic formats suitable for conveying and delivering ad 16 include: an email, an instant message, a text message (SMS or MMS), in situ ad in a web browser, a weblog (blog), a social network environment, a news feed, a webpage, a status post, a twitter update, graphics for display on a display device, etc.

In one embodiment, the system 2 can be configured to allow the ad suggester 4 to personalize an interpersonal ad, such as 16. For instance, in father son jewelry example, the son can send a note to father saying, “I overheard mom talking about this item at the jewelry store.” This note can be displayed with the interpersonal ad 16 sent to the father. The note allows the father to confirm the relationship with the sender (son) and additionally provides consumer information 6 that can aid the father 8 in the purchase. The addition of the consumer information 6 may increase the likelihood that purchase associated with the ad 16 occurs.

Recipient 8 may view an ad 16 in a wide variety of digital communication environments. In one embodiment, a social network environment displays the ad 16. In another embodiment, ad 16 is displayed in an online chat, instant message, mobile application, text message, or email. Ad 16 may also be displayed in the space of the recipient's internet browser dedicated to displaying ads. This may be done for any web page visited by the ad recipient. Other display schemes are contemplated and ad 16 is not limited to any specific display arrangement for ad 16.

It is contemplated that some actions performed by intended recipient 8 may be performed while intended recipient 8 is not online. For example, intended recipient 8 can receive advertisement 16 on a mobile device and subsequently travel to an offline location, e.g. a store, maintained by an advertiser, or an affiliate of the advertiser, such as a merchant, retailer, wholesaler, among others. Printed ads from a computer also permit an alternative to recipient 8 from needing to bring his electronic device to a brick and mortar participating store. The printed ad can include identifying information that allows the ad to be identified as an interpersonal ad from system 2. The recipient 8 may also use a mobile device to initiate and/or complete a transaction in an online marketplace or in a brick and mortar participating store. Such mobile commerce techniques are known to those of skill in the art. In one example, the recipient's mobile device digitally contains payment information, such as a credit card number. Participating storefronts or merchants permit the recipient to use the mobile device as a method of payment, such as using near field communication technology.

### Compensation in an Interpersonal Electronic Advertising System

System 2 can be configured to track what recipient 8 does in response to receiving ad 16. The tracked information can be used to attribute compensation to suggester 4. The tracking can include but is not limited to determining whether the recipient has acknowledged receipt of the ad, whether the recipient has visited a physical or virtual location associated with the ad and whether a purchase has resulted in response to receiving the ad 16.

In one embodiment, to determine whether an ad has resulted in a purchase, during a transaction for a product or service, recipient 8 may present an ad 16 where the ad 16 includes a bar code or other identifier for the ad 16 that represents advertisement redemption data that was originally supplied by the store. Further, the ad 16 can include information that links it to system 2. During a transaction where ad 16 is utilized, the recipient's device, such as 5b, and/or a device controlled by a merchant associated with an ad may then send a message to system 2 indicating that a transaction occurred. The system 2 can be configured to store this result to storage 30 as a successful ad suggestion for suggester 4. As is described in more detail below, information related to successful suggestions can be used to rank interpersonal ads that are displayed via system 2. The compensation module 32 can receive information regarding the successful ad suggestion and use it to attribute compensation to the ad suggester 4.

In one embodiment, the store, advertiser, affiliate, or intended recipient 8 can take action to provide information to the system 2 that verifies that a particular transaction occurred in response to electronic advertisement input 10. For example, the advertiser, affiliate or intended recipient 8 accesses a network and transmits notification of a successful consumer transaction made by recipient 8 relating to the ad 16 or digital coupon 16 created by suggester 4. In other embodiments, system 2 implements automated notification of a transaction by recipient 8 and a store based on ad 16. So long as system 2 receives affirmation of a consumer transaction relating to ad 16, then system 2 knows that the transaction occurred and may attribute a compensation to ad suggester 4 or another financial destination designated by suggester 4 (such as a bank account for a charity designated by suggester 4).

The compensation module 32 can be configured to attribute an incentive or compensation within interpersonal advertising system 2. Compensation can refer to any type of incentive, whether monetary, or in another form such as a discount on a present or future consumer transaction, coupon, merchandise, award, products, services, electronic tokens, virtual currency, rebate, among others.

Compensation module 32 can attribute compensation to a compensation destination designated by suggester 4. Module 32 can attribute compensation to ad suggester 4, such that compensation is accessible to the ad suggester. In another embodiment, compensation can be attributed to a destination specified by suggester 4, such as a charity for which suggester 4 is trying to raise funds. In this instance, the compensation may not be accessible to the suggester 4 once it has been attributed. However, the system 2 can be configured to maintain records accessible to the suggester 4 that indicate a number and an amount of compensation that has been attributed to entities other than the ad suggester 4.

To allow compensation, the system 2 can be configured to receive information, such as electronic payment information, that allows compensation to be transferred to an account specified by the ad suggester. For example, to enable personal compensation, an ad suggester 4 may provide a personal checking account number to system 2 via an interface generated or supported by the system 2, such as an interface supported by the ad creation interface module 12. The compensation enabling information can be stored to storage 30.

When it is time to attribute compensation to the ad suggester, the compensation module 32 can retrieve the previously specified payment information. For example, when payment information includes checking information, the compensation module 32 can subsequently deposit funds in the specified checking account using the retrieved payment information. In general, the payment information can be related to: a bank account, a PayPal™ account, Spare Change account, among others. Bank accounts may include personal accounts, business accounts, those for charitable organizations, etc. Digital credits and tokens are also suitable for use.

As noted above, compensation as contemplated herein is not limited to direct compensation of the ad suggester 4. For example, a grandparent may designate attributed compensation to the bank account for a grandchild. A suggester that supports a charity may designate the charity, or a specific bank account for a charity if known, as a financial destination for one or more ad revenues. Multiple people may also specify the same charity, thereby cumulatively generating significant funds for the charity only using actions by its supporters. Thus, the payment information input into system 2 can be associated with a financial destination that is not accessible to the ad suggester 4.

In particular embodiments, the system 2 can be configured to allow an ad suggester 4 to attribute compensation to a financial destination on ad by ad basis. For instance, the ad suggester 4 can designate that if a first interpersonal ad results in compensation the proceeds will be credited to the ad suggester and that if a second interpersonal ad results in compensation the proceeds will be credited to a third party, such as a charity. The system 2 can be configured to allow a user to view for each interpersonal ad the designated recipient of compensation that may result from ad and allow the user to change a previously specified designated recipient of an interpersonal ad.

Compensation module 32 can receive a notification that recipient 8 activated electronic advertisement 16. A component of system 2, such as module 32, may place or embed a tracking identifier and/or tracking program for an advertisement, such as 16. The identifier or tracking program can include a unique identifier or software used to track the status of the ad, such as an alphanumeric code, a hexadecimal string, a cookie, etc. Whenever recipient 8 activates the ad, that activation can be tracked by module 32. If a product or service is purchased, then recipient 8 pays the advertiser, vendor or seller, or an intermediary for either, and the advertiser, vendor or seller compensates electronic advertising provider 28 for that activation. In one embodiment, compensation module 32 uses cookies to track ad and purchase status or other recipient 8 activity in response to an ad 16.

FIG. 2 illustrates a method 101 for attributing an incentive or compensation within an interpersonal advertising system in accordance with a specific embodiment of the present invention. Method 101 begins by receiving a designation of a compensation destination (103) for compensation resulting from providing input for an interpersonal advertisement. Compensation may be attributed to any bank account or other suitable electronic compensation destination. For example, an ad suggester may provide a personal checking account number to the interpersonal ad service at 103. The payment information associated with the compensation destination can be used to subsequently send funds to the location specified by the payment information.

Next, in 105, an ad can be created by an ad suggester and ad sent to an ad recipient. Next, in 107, a notification that the ad recipient activated an electronic advertisement can be received. Activation of an electronic advertisement may include one or more of: 1) completing a transaction that was initiated using the interpersonal ad (e.g., the recipient was sent to a website to make the purchase using a link embedded in the ad 16), 2) completing a transaction that otherwise corresponds to interpersonal ad (e.g., the ad brought the ad recipient to a retailer's website, and the recipient purchased a product or service similar to the product or service conveyed in the electronic ad but not the particular product or service conveyed in the electronic ad), 3) acknowledging the interpersonal ad (e.g., opening an e-mail or text including the interpersonal ad), 4) visiting a physical or virtual location associated with the interpersonal ad or combinations thereof.

In one embodiment, the system can attempt to proactively or periodically verify whether the intended ad recipient has activated an interpersonal advertisement. If the recipient activated the electronic advertisement, then method proceeds to 111. If the intended recipient hasn't activated an interpersonal ad, after some time period, a check can be made again to determine whether an interpersonal ad has been activated. The system can continue make these checks until the verification returns an affirmative result or until the interpersonal ad is terminated.

As described above, a tracking number and/or tracking program can be embedded in an interpersonal ad. The tracking numbers can refer to one or more unique identifiers used to track the status of the interpersonal ad. When an interpersonal ad is in an electronic format, a tracking program can be embedded in the interpersonal ad. When the interpersonal ad is activated, the tracking program can be configured to report a unique identifier back to the interpersonal electronic advertising system.

Thus, whenever a recipient activates the ad, that activation can be tracked online and signaled to the interpersonal electronic advertising system. If a product or service is purchased and the recipient pays the advertiser, vendor, or seller, or an intermediary, the advertiser, vendor or seller can compensate the interpersonal electronic advertising system. Next, the proceeds can be divided between the ad suggester, an operator of the interpersonal electronic advertising system and possibly a third-party partner associated with the operator.

In one embodiment, electronic tokens, such as cookies, can be used to track interpersonal ads, a purchase status associated with ad and/or other recipient activity resulting from receiving the interpersonal ad. In a specific embodiment related to online use, cookies can be used in two stages of online recipient tracking: 1) at the load of the interpersonal ad and 2) when the interpersonal ad is clicked and the recipient that initiated the click is delivered to the seller or a website to make a purchase. Thus, the use of cookies can enable compensation for an ad suggester when the recipient activates an interpersonal ad. This compensation can be separate from the compensation that results if a purchase is actually made.

Next, in 111, compensation can be attributed to the operator of the interpersonal electronic advertisement system 2 described above in FIG. 1. In one embodiment, only the operator of the system and the ad suggester share the proceeds resulting from a successful purchase. The proceeds can be paid by a vendor that benefited from the purchase enabled by the ad suggester and the interpersonal ad provided by the interpersonal electronic advertising system. In a specific embodiment, the ad suggester and the system operator split the proceeds 75/25. In another specific embodiment, the ad suggester and system operator split the proceeds 33/67. Other splits are possible and are not limited to these examples.

In other embodiments, more than two parties can split the proceeds resulting from a successful ad suggestion. For instance, a social network site can host an ad creation interface. The ad creation interface can be coupled to the interpersonal electronic advertisement system. Proceeds associated with the activation of the interpersonal ads generated from the hosted interface can be split among the ad suggester, the operator of the social network site and the operator of the interpersonal electronic advertising system. In another specific embodiment, the electronic ad service provider receives compensation for providing the advertisement to the intended recipient, without any further activity by the recipient. If the ad was sent to the recipient via a social network, method 101 can attribute at least a portion of the compensation to the social network. If a purchase subsequently results from the ad, then additional compensation can be attributed to one or more entities that participated in the process leading to the purchase.

Next, in 115, compensation can be directed to the financial destination associated for the interpersonal ad. The financial destination may have been designated in 103. In one embodiment, in 115, a record of the suggester's electronic advertisement input and the interpersonal ad that corresponds to the input which was sent to the intended ad recipient can be stored. Further, the system can store a record indicating that the compensation has been attributed including information regarding the designated recipient of the compensation.

Compensation for a purchase may vary. In one embodiment, process flow 101 attributes compensation to an ad suggester based on a percentage of a transaction, where the percentage does not change over time. A compensation percentage that does not change between successive activated ads is referred to herein as a ‘flat rate’ compensation percentage. In the jewelry store example described above, the son may receive a flat rate compensation percentage for all of his interpersonal ads, such as 5%, therefore receiving 5% of the transaction price of his father's purchase at jewelry store.

In another embodiment, a variable compensation structure can be implemented. For example, an ad suggester can be paid a higher compensation percentage on their first ad that is successfully acknowledged by an ad recipient, or their first ad that successfully resulted in a purchase by the ad recipient. The higher initial compensation might be used as incentives in order to enlist new ad suggesters to utilize the system. After the first ad is acknowledged and/or results in a subsequent purchase, a second compensation percentage (e.g., a lower flat rate) can be implemented for the ad suggester.

In another specific embodiment, the ad suggester can receive a compensation percentage until a minimum number of ads are sent, so as to provide initial incentive to utilize the interpersonal advertising system. After the minimum numbers of interpersonal ads are sent, the incentive structure can change, e.g., it can go to a flat rate or becomes variable according to the tiered system. In this second instance, once the minimum numbers of ads are sent, the system can be configured to change the incentive in relation to the number of successful activations. In this manner, an ad suggester receives a first compensation percentage for an initial threshold number of ad suggestions, and receives a variable rate of return, as further described above, once the initial threshold is met.

In some embodiments, the dynamic rate of return does not fall below the initial flat rate. For example, a sample incentive scheme offers compensation for the first twenty interpersonal ad activations at 5% of the corresponding transactions. The ad suggester's first interpersonal ad can be a jewelry store ad to his father. The father can activate the ad by using it at jewelry store in a consumer transaction. The total purchase price can be $500, the ad suggester (son) son receives $25 since it was son's first interpersonal ad. The son can continue to receive this 5% rate for activations of his interpersonal ads until he provides twenty (or some other threshold) interpersonal ads that result in ad activations. Subsequently, another transaction scheme, such as a variable compensation scheme can be utilized.

Other compensation schemes are contemplated. In another embodiment, the compensation percentage varies in relation to the total amount of the transaction price. For example, the incentive rate for a $100 ski rack might be 5%. Thus, the ad suggester of the ski rack receives $5 dollars when a purchase results from the interpersonal ad. Whereas, the incentive rate for a $10,000,000 home purchase or yacht might be 1% and the ad suggester receives $100,000 dollars. In this manner, a business can control how much it rewards suggesters to bring customers to the business. In another compensation scheme, a flat fee for a purchase can be implemented that is irrespective of the purchase price or conversion rate or any other factor. For example, an ad suggester $3 can be paid for a certain ad that converts into a purchase by the recipient.

After attribution of compensation in 115, the 101 may repeat and return to 89 and new electronic advertisements can be sent to the recipient.

### Ad Suggestion Effectiveness Metrics

In the embodiments, described herein different metrics can be generated to characterize an ad suggester's effectiveness at suggesting ads to ad recipients. The ad suggester's determined effectiveness can vary from recipient to recipient. For instance, an ad suggester may be very effective at suggesting ads for their parents but not so effective at suggesting ads for their younger sibling. As another example, an ad suggester may be very effective at suggesting ads for their spouse but not so effective at suggesting ads for their adult children.

Besides from person to person, an ad suggester's effectiveness can be defined in many different ways. For instance, a metric of an ad suggester's effectiveness can be determined within different price ranges, such as effectiveness at suggesting ads for products between $1000 and $500 dollars as compared to ads for between $100 and $50 dollars. As another example, a metric of an ad suggester's effectiveness over time can be determined In yet another example, a metric of an ad suggester's effectiveness within product categories can be determined, such as travel products or furniture. Further, a metric of an ad suggester's effectiveness can be determined for ads created for a particular product. These metrics are provided for the purposes of illustration only and are not meant to be limiting.

The metrics listed above can be determined on a per person basis or on a group basis. For instance, an ad suggester's effectiveness at creating ads for products or services between $500 and $100 dollars can be determined for ads sent to a particular ad recipient over time. In another example, an ad suggester's effectiveness at suggesting ads for products and between $500 and $100 can be determined for interpersonal ads sent to a group of recipients over time. In yet another example, an ad suggester's effectiveness can be determine for interpersonal ads sent to recipients in particular age ranges, such as over 50 years of age or between 20 and 55 years of age. The metrics listed above can also be determined for different time periods, such as the last week, last month, last 6 months, last year, etc.

One metric for measuring an ad suggester's effectiveness at selecting interpersonal ads for ad recipients can be referred to as a conversion rate. In one embodiment, a first type of conversion rate can correspond to a total number of ad activations resulting in purchases relative to a number of interpersonal ads sent. In another embodiment, a second type of conversion rate can correspond to a total number of ad activations including activations resulting in purchases and activations resulting in non-purchases (e.g., the ad is selected, the ad recipient goes to a site displaying products associated with the advertisement and views additional advertising. However, the ad recipient doesn't purchase a product or service associated with the interpersonal advertisement.)

The conversion rate may be determined using a number of techniques and with a variety of inputs. For example, one suitable conversion rate can use a ratio of a number of prior interpersonal ad activations (purchase only) for a suggester related to the number of prior of interpersonal ads sent by the ad suggester over some time period. The conversion rate may be determined using statistics between: a) an ad suggester and ad recipient, b) an ad suggester and all his ad recipients, c) an ad suggester and a group of contacts (e.g., ski trip friends, or college friends, etc.), d) an ad suggester and his family and/or e) combinations thereof. In a specific embodiment, the conversion rate is a global conversion rate for all the interpersonal ads sent by a suggester and is determined at the time of sending an advertisement to the recipient. It is noted these types of determinations can also be utilized for other metrics associated determining an effectiveness of an ad suggester and is not limited to the conversion rate.

Effectiveness metrics, such as conversion rates, can be used in the systems and method described herein for different applications. In one embodiment, effectiveness metrics can be employed in the compensation methods described above with respect to FIGS. 1 and 2. A variable rate of compensation tied to an effectiveness metric, such as a conversion rate, can be used within the interpersonal electronic advertising system to incentivize ad suggesters to provide electronic advertisement input and ads that are highly likely to result in purchases by recipients. It can also be used to disincentive spamming where a user tries to send a large number of interpersonal ads with a low probability of succeeding. Examples of utilizing a conversion rate in a compensation scheme are described with respect to the following paragraphs. When used in the method 101 described above with respect to FIG. 2, the conversion rate can be periodically updated so that a compensation percentage can reflect changes to the conversion rate.

In the jewelry store example, the conversion rate can be used to determine the son's compensation on his father's purchase. As described above, the conversion rate can be calculated in many different manners, such as on a per recipient basis or globally. For example, if the son in the jewelry example previously sent forty interpersonal ads and twenty were activated for purchases, then his conversion rate would be 50% interpersonal ads leading to purchases. If all forty of his ad suggestions were activated for purchases, the son's conversion rate would be 100%. As the son's conversion rate increases, the system can be configured to increase his compensation for a given activation. Likewise, as his conversion rate decreases, the system can be configured to lower his compensation. In this manner, son is incentivized to select interpersonal advertisements that are more likely to result in recipient activation. In one embodiment, if an ad suggester's rate becomes very low over some time period, i.e., the suggester is an ad spammer, the system can be configured to block the suggester from sending additional interpersonal ads.

In accordance with the example in the previous paragraph, the system can be configured to use a tiered conversion rate scheme to attribute compensation to an ad suggester. The tiered scheme can includes a number of tiers for the ad suggester's conversion rate, where each conversion rate tier conveys a dedicated compensation rate. Changes (up or down) to the ad suggester's conversion rate can cause their compensation to move between the conversion rate tiers and their predetermined conversion rate thresholds resulting in different compensation rates. Typically, a higher conversion rate tier results in a higher compensation percentage using the tiered system. For an increasing conversion rate, once the next conversion rate threshold number is reached, the system can be configured to increase the compensation percentage.

As described above, the conversion rate can vary over time. In one embodiment, a compensation percentage of the transaction can be based on the ad suggester's conversion rate at the time of sending the ad. In another embodiment, the compensation percentage of the transaction can be based on an average of the ad suggester's conversion rate at the time of sending the ad and the ad suggester's conversion rate at the time the ad is activated. In general, a conversion rate used to attribute compensation can be based upon conversion rates calculated at one or more times when compensation is being attributed for a particular interpersonal ad.

In a particular example, the conversion rate used to attribute compensation can be determined at the time an ad is created. In the jewelry example, if the son's conversion rate is 19%, and he suggests a jewelry store ad to father, and father activates the jewelry ad, the ad activation, depending on how the conversion is calculated, can elevate the son's conversion rate above 20%. When the conversion rate tiers are set at 10% increments, such as 10%, 20%, 30%, 40%, etc., the new higher conversion rate indicates the son may possibly earn additional compensation. In this embodiment, however, the system is configured to determine conversion rate at the time the ad is created for the purposes of attributed compensation. Thus, since the son created the ad while his conversion rate was 19%, the system is configured to receive compensation based on the compensation structure for a 19% conversion rate. On future activated ads, however, the son is eligible for the higher compensation at the compensation rate given to the high tier at 20%, while his conversion rate remains above 20%.

A tiered conversion rate compensation scheme may employ any number of tiers, where each successively higher tier conveys an increased compensation percentage, and each tier having a threshold conversion rate to qualify for the increased compensation percentage. When the conversion rate decreases to below the threshold level for a tier, the suggester's compensation percentage decreases to correspond with the lower conversion rate tier.

As described above, an ad can be output via an interface that is configured to receive an input that indicates the ad has been acknowledged. For instance, via a GUI, an ad recipient can provide an input via an input device, such as a touch screen, a mouse or a track pad, that indicates a selection of the ad by the ad recipient. As another example, via an oral interface such as a digital assistant like Siri by Apple™ the ad recipient can request, verbally, information about the interpersonal ad. In response, the digital assistant can output a verbal description of the interpersonal advertisement. In yet another example, an eye tracking device can be used with a GUI to determine whether a user has looked at an advertisement. The tracked position of the user's eyes such as if they lingered at a location of the interpersonal ad can indicate awareness of the interpersonal ad. The input received from an interface from which an interpersonal ad is output can be used by the system to determine the ad recipient has acknowledged the ad in some manner. In response to the acknowledgement of the interpersonal ad, the system can attribute compensation to the ad suggester. Further details of interfaces that can be used to output ads are described below in the following section.

### Interfaces for Outputting Interpersonal Ads

As described above, various types of interfaces can be used to output interpersonal ads derived from an interpersonal electronic advertising system. Many types of interfaces can be primarily graphical in nature. However, other types interfaces, such as interfaces that are primarily sound based, like an interface based upon verbal commands and verbal responses using a digital assistant like Siri from Apple,™ can also be utilized. Various input and output devices can be used to allow a user to interact with the interfaces. Examples of input devices that can be utilized include but are not limited to 1) touch sensitive devices, 2) sound detection devices that can include speech processing capabilities, 3) motion detection devices, such as devices incorporating cameras or accelerometers to detect motion to indicate inputs, and 4) mechanical devices such a keyboard or a mouse. Examples of output devices used with an interface can include but are not limited to video displays, sound generation devices that can include speech synthesis capabilities and haptic devices that generate detectable vibrations.

FIG. 3 illustrates a graphical user interface 201 for displaying a viewable page including one or more interpersonal ads, such as a page output via a web-browser. The interface 201 is configured to allow ad suggesters to contribute at least a portion of the content 45 that is displayed to the page. As shown, the page displayed by the interface includes locations for the placement of up to three advertisements where one or more of the placed ads can be interpersonal ads. Other pages formats are possible and the example is provided for the purposes of illustration only. The content 45 displayed on the page can vary depending on the purpose or theme of the page.

In one embodiment, the viewable page can be owned by a particular individual. Ownership may allow the individual to change aspects of what is displayed on the page at a particular time. In some instance, the interface 201 can be configured to generate a viewable page with one or more of a contacts module 175, an ad creation interface link 205 a dashboard link 207. The contacts module 175 can include a list of individuals associated with the owner of the page. As described below, the interface 201 can be configured to allow a user to create ads for individuals or groups of individuals. In some instances, contact information for the individuals or groups of individuals can be retained in the contacts module 175.

A selection of the ad creation interface link 205 can cause interface 201 to generate a page that allows a user access a database of products and services that can be selected for particular ad recipients, such as individuals stored in the contact module 175, to together create an ad. A selection of the dashboard link 207 can cause the interface 201 to generate a dashboard page that allows the user to assess a status related to the interpersonal ads they have previously created. For instance, via the dashboard page, a user can view information such as but not limited to a list of interpersonal ads they have previously sent, whether interpersonal ads have been activated and by who, ad suggestion effectiveness metrics, such as conversion rates related to the activation of interpersonal ads, past attributed compensation, etc.

In one embodiment, an interface for displaying interpersonal ads can be compatible with social media applications. When the interface 201 is used a social media environment, a portion of the content 45 that is displayed can be social media related. In other contexts, the content 45 displayed in the interface can be different. For example, if the interface 201 is used to access a web-site, the content 45 that is displayed can be consistent with a theme of the web-site.

In a specific embodiment, the interface 201 can output a social network profile page associated with a particular individual. In this case, the social network content 45 can include content personal to the individual. As an example, the content 45 can include news feeds, a status post, a news update, etc. of interest to the individual.

In one embodiment, the interpersonal electronic advertising system can be configured to allow an individual to suggest ads for visitors to their social network profile page that are displayed via interface 201. In this example, ads 16a, 16b and 16c can be interpersonal ads selected by the owner of the page. When other individuals with a relationship to the individual visit the page, the interface 201 allow the visitors to activate the displayed interpersonal ads, such as 16a, 16b or 16c. After the interpersonal ads are activated, the owner of the social network profile page (ad suggester) can be compensated. The compensation rewards the page owner's efforts related to suggesting ads, gathering consumer information and social networking activities.

In one embodiment, when a social profile page is visited, the same interpersonal ads are displayed to everyone. In other embodiments, the system is configured to customize the interpersonal ads to each visitor. Thus, the ad suggester can suggest ads that are for an individual ad recipient or a group of ad recipients that visit their page. When an individual visits the page, the system can be configured to identify the visitor and then determine whether there are any interpersonal ads for the individual from the owner of the page. In one embodiment, when the owner of a page visits their own page, the system can be configured to display ads created for them from other individuals and/or ads they can select for others.

In the jewelry example described above, the son can create a social profile page via interface 201. Then, the son can select an interpersonal ad for their father, such as the jewelry advertisement. The interpersonal ad can be delivered to the father via some communication mechanism, such as text or e-mail. In addition, when the father 8 visits his son's page, the system can be configured to identify the father and determine whether there are interpersonal ads just for the father or the father falls within any groups that have been designated to receive a particular interpersonal advertisement. As an example, the son's 4 interpersonal advertisements for his father can include a jewelry store interpersonal ad 16a, a new family computer interpersonal ad 16b, and a sports car interpersonal ad 16c. Thus, father 8 visits his sons social profile page and the father can view a number of interpersonal ads from his son, such as 16a, 16b and 16c. As noted above, the system itself can also suggest ads for the father.

In some embodiments, the number of interpersonal ads for the father can be greater than the number of ad locations available on the page. For example, a son may have selected ten interpersonal ads for their father. However, only three locations are available for displaying the ads. In this situation, the system can be configured to rank each of the interpersonal ads relative to one another and display the top three ads.

When someone else visits the son's social profile page, a different set of ads can be displayed. For example, when his mother visits his page, a interpersonal ad for books the mother wants can be displayed in ad 16a, a interpersonal ad for a new family computer displayed can displayed in ad 16b, and a interpersonal ad for a spa getaway package in ad 16c. In the example, the interpersonal ad for the new family computer is displayed to both the mother and the father. The son may have selected that the ad for the computer to be displayed to family members. Further, the son may have identified the mother and the father as family members to the system. When the mother or father logs onto the system, the system can determine that the father or the mother are family members and then determine the new family computer interpersonal ad is to be displayed to each of them.

In general, the system can be configured to allow an ad suggester to define groups and then suggest ads for the group. For instance, the system can be configured to allow the ad suggester to create a group and then populate it from their contacts using the contacts module 175. The system can be configured to allow the user to delete or modify the members in a particular group. In particular embodiments, the system can be configured to allow an ad suggester to select the same interpersonal ad for multiple different groups.

As an example, an owner of the page can select the ad creation interface link 205 and the interface 201 can display an ad creation interface page. Via the interface, an ad can be selected for a discount ski pass for a particular resort 16. Next, the interface 201 can be used to create and populate a group, such as “ski friends.” Then, the ski pass interpersonal ad can be selected for the group “ski friends.” When someone in the ski friends groups views the social network profile page via interface 201, the system can identify the person as being a member of the ski friends group and the interpersonal ad for the particular ski resort can displayed. The ad suggester can be compensated at least each time one of the friends in the group purchases a lift ticket via the advertisement.

The interface 201 is not limited to displaying only three ads. In general, the interface can be configured to output one or more ads. The number of ads that are displayed to a page can vary over time. In addition, the system can be configured to vary the size and the placement location of the one or more ads displayed to a page at a given time. Further, the system can be configured to vary the content and format of a displayed advertisement. For instance, at one time, the content and format of a first interpersonal ad for a product can include selected content formatted to be output as a video with sound. In another embodiment, a second interpersonal ad for the same product can include selected to be output as a still image without sound.

Multiple interpersonal ads can be provided for the same product and the system can be configured to select from among the multiple ads to output via the interface. For example, at a first time, a first interpersonal ad 16a can be output for a particular product. Then, at a later time, the system can refresh the social media profile page and a second interpersonal ad for the same product can be displayed.

A particular number of ad spaces in which interpersonal ads are output can be specified for a particular page format. For example, in FIG. 3, the page is configured with 3 ad spaces. In some embodiments, the number of interpersonal ads for available for a particular page format can be less than or greater the number of ad spaces that are available for interpersonal ads. When the number of interpersonal ads is less than the number of ad spaces, in one embodiment, the system can be configured to suggest ads to fill the unallocated ad spaces. In another embodiment, the system can be configured to only display the one or more available interpersonal ads. For example, if only one interpersonal ad is available, then for the page in FIG. 3, only one interpersonal ad might be displayed in location 16a and the locations for 16b or 16c can be left blank or the only interpersonal ad can be displayed in all three locations. In yet another embodiment, the system can be configured to reformat the page to reduce or eliminate the unfilled ad spaces. For instance, if one interpersonal ad is available, then the interface can be configured to expand the size and/or rearrange the remaining components, i.e., ad 16a, content 45, contacts module 175, ad creation interface link 205 and dashboard link 207 such that at least a portion of the available space associated with 16b and 16c is filled by the other page components.

When the system determines that more interpersonal ads are available then ad spaces are available on page, in one embodiment, the system can be configured to adjust the format of the page to increase the available ad spaces. For instance, if four interpersonal ads are available for the page shown in FIG. 3, the system can be configured to adjust the format of interface 201 to include 4 ad spaces instead of 3. The re-formatted can involve rearranging and resizing various components on the page.

In another embodiment, when more interpersonal ads are available for a page then ad spaces the system can be configured to rank the ads. Based upon the rankings, the system can distribute the ads to the ad spaces available on a page provided by interface 201. For example, if the system determines ten interpersonal ads are available for the page shown in FIG. 3, then the system can be configured to rank in order each of the ten ads and then display the three highest ads to ad spaces 16a, 16b and 16c.

### Dashboard Interface Components and Layout

In this section, an interface that allows a user to monitor their activities within the interpersonal electronic advertising system is described. The interface can be referred to as a “dashboard” interface. FIG. 4 illustrates components of a dashboard interface configured to allow a user to monitor their activities within the system. A layout 200 showing one embodiment of an arrangement of the dashboard interface components is described as follows.

The top right corner of the layout 200 can include a logo 202. In the example, a logo for TrustedAd™ is shown. The logo 202 is associated with an operator of the interpersonal ad system. At the top center of the page, a selectable link 204, “Send and Ad,” is shown. A selection of the link 204 can cause the system to generate an interpersonal ad creation interface. The interpersonal ad creation interface can allow a user to generate and send an interpersonal ad to an ad recipient.

A welcome “user” message 204 is displayed in the top left corner of the layout 200. The welcome user message can include a portion of the user's name, such as the first name “Will.” The user's name can be associated with an account holder that has logged into the system where the dashboard interface includes information that reflects the logged-in user's activities on the system.

The “faq” 210 can be a selectable link. A selection of the FAQ link 210 can cause the system to generate one or more interface screens that include frequently asked questions and answers to the questions. Some examples of questions that can be included in a faq include but are not limited to a) “How many ads can I send?,” b) “When do I get paid,” c) “What happens if the ad recipient returns a purchase?”, d) “Have a question about a commission?”, e) “Can I change a financial destination before the commission pays?”, f) “Can I change a financial destination for a commission after the commission pays?” g) “Do commissions given to a charity count against me for tax reasons?”, and h) “Can I send ads to myself?”. Some example answers to these questions are described as follows.

In particular embodiments, the answer to “How many ads can I send?” can be “As long as your conversion rate remains above X % (e.g., 5% or 10%), the number of ads you can send is unlimited. Your account starts in a Y day trial period (e.g., 60 Days), during which you are limited to Z ads (e.g., 20 ads) until your interpersonal ads guide purchases. If you send Z ads without guiding a single purchase, then the system prevents you from sending new ads.” The answer to “When I get paid?” can be “The system does not get paid until the ad recipient's purchase clears the merchant's internal payment protocols. Each merchant pays at different rates. The merchant processing time is usually listed when an ad is selected for sending. When creating and sending an ad, the system encourages ad suggesters to select merchants that pay ad suggesters quicker.”

The answer to the question “What happens if the Ad recipient returns a purchase?” can be “Each merchant has different terms that will affect returns. The ad terms will briefly explain these terms. Merchants and the system do not pay commissions for returned items. A returned ad shows up as a red processing arrow in the ad status window.”

The answer to the question, “Can I change a financial destination for a commission before the commission pays,” can be “Yes. Just click on the financial destination for an ad in the ad status window. This needs to be done at least X days (e.g. 3 or 5 days) before the commission is scheduled for payment.” The answer to “Can I change a financial destination for a commission after the commission pays?” can be “No.” The answer to “Do commissions given to charity count against me for tax reasons?” can be “No. The commissions are paid directly from TrustedAd™ to the Charity that you have selected. You do not get to use these as a write off since the money was never actually paid to you.”

In different embodiments, all or a portion of the questions as well as additional questions can be included in a FAQ. Also, the answers to the questions can depend on a system configuration and can change depending on how the system is configured. For example, system can be configured such that the minimum conversion rate is 15%, the trial period is 30 days instead of 60 days and the cut-off at which the system stops are user from sending ads can be 15 ads instead of 20 without guiding a purchase. In this configuration, the answer to the question “How many ads can I send” can be “As long as your conversion rate remains above 15%, the number of ads you can send is unlimited. Your account starts in a 30 day trial period, during which you are limited to 15 ads until your ads guide purchases. If you send 15 ads without guiding a single purchase, then system prevents you from sending new ads.”

Returning to FIG. 4, a sign out link 208 is located in the top right corner of the layout 200. In one embodiment, a selection of the sign out link 208 can cause the system to log the user off the current screen and return the interface to a home or default screen associated with the system. At the home screen a link can be provided that allows a user re-login to the system if desired and again access the dashboard interface.

The recent ads component 214 can include a list of interpersonal ads. The list can be output in a text or graphical format. The list can include interpersonal ads that the logged in user has sent to various ad recipients or can include interpersonal ads for the user (as an ad recipient) from other users of the system. In one embodiment, one or both of the lists of interpersonal ads that the user has sent or has received from other users can be displayed simultaneously in the layout 200. For example, the interpersonal ads that the user has sent to other individuals can be displayed on a right sight side of the layout and the interpersonal ads that the user has received from other users can be displayed on the left side of the layout 200 in a vertical format. In another example, the interpersonal ads that the user has received can be displayed on a top of the layout 200 in a horizontal format, such as a horizontal strip above the profile 212 and the interpersonal ads that the user has sent can be displayed on a bottom of the layout 200, such as a horizontal strip below the ad status 232. In FIG. 4, only a single vertical strip 214 on the right side of the layout 200 is shown.

In one embodiment, a rank value for the interpersonal ads in a group can be determined A list can be generated and ordered according to the rank value. Factors that can affect the rank value can include but are not limited to i) when the interpersonal ad was sent, ii) a commission associated with the interpersonal ad and iii) an ad suggestion effectiveness metric between the ad suggester and the ad recipient, such as a conversion rate. A depiction of a list of interpersonal ads sent by the user including text and graphical elements is described in more detail with respect to FIG. 5A. A depiction of a list of interpersonal ads received by the user including text and graphical elements is described in more detail with respect to FIG. 5B.

A number of interpersonal ads on the list that can fit between the up arrow 216 and down arrow 230 in space 218 can be less than the number of interpersonal ads on the list. To view interpersonal ads that are not shown at a particular time, a user can select the up arrow 216 or down arrow 230. A selection of one of these arrows can cause the system to scroll through a generated list of interpersonal ads such that interpersonal ads that are not currently shown are shown and interpersonal ads that are currently shown are not shown. The order that the interpersonal ads on the list appear and disappear can depend on how the list is generated. For example, as described above in the previous paragraph, the list can be ordered according to a determined rank value. In another example, the list can be ordered chronologically according to when the interpersonal ads were sent.

The profile interface component 212 can include information about the user's profile on the system. For instance, the profile interface component 212 can include one or more of an image of the user, an amount of commissions paid, an amount of commissions pending, a value of an ad suggestion effectiveness metric, such as a global ad suggestion effectiveness metric between the user and all ad recipients to whom the user has sent ads, a message ticker displaying recent information, a commission rank and link that causes the system to display additional account information. Further details of the profile interface component 212 are described below with respect to FIG. 6.

The account activity interface component 220 can include various details about a user's activities on the system from different perspectives. For instance, sections 222 and 224 can include values of parameters that characterize a user's activities within the system. The information in sections 222 and 224 can allow a user to evaluate their performance in the system. For example, section 224 can include information about interpersonal ads that the user has sent and that have resulted in purchases. Section 222 can include details about how the user has been compensated from their activities on the system, such as revenues earned over particular time periods. Further details of the section 222 and 224 are described below with respect to FIG. 7.

Another component of the account activity section 220 can be recent ad activity interface component 226 which displays information and ticker messages related to recent ad activity. Ticker messages may include any messaging for the user related to their ads or account. Examples include: you just got paid, someone purchased using one of your ads, referral rewards program messages and updates, etc. Interface component 226 can include information and ticker messages about interpersonal ads that have been sent by the user, including information about the product described in the ad, its cost and the recipient of the ad. The recent ad activity and ticker messages can be listed in a chronological order according to the time each interpersonal ad was sent or ticker message was sent to the user. Interface component 226 can also include information and ticker messages about interpersonal ads that have been received by the user from other ad senders. Additional details of the ad activity section 226 are described below with respect to FIG. 8.

The referral interface component 228 can include information about a referral rewards program where a user can earn rewards based upon the activities of new users that the current user has invited to the system. The interface component 228 can include information, such as how many individuals the user has invited and their progress towards rewards in the program. Further details of the referral interface component 228 are described below with respect to FIG. 9.

The ad status interface component 232 can include information about the interpersonal ads a user has sent. This includes information about each ad, the ad recipient, a commission associated with the ad, whether a purchase has resulted from the ad and whether compensation has been received as a result of the purchases. Additional details related to the ad status interface component are described below with respect to FIG. 10.

In various embodiments, the account activity section 220 can include outputting all or fewer of interface components 222, 224, 226, 228 and 232. For example, a user can select to display only sections 226, 228 and 232 and the activity section 220 can be generated without interface components 222 and 224. In another embodiment, each of interface components 222, 224, 226, 228 and 232 can be expandable or collapsible. One or more buttons can be provided that when selected cause and associated interface component to collapse or expand. For example, in one state, the interface component 228 can be collapsed and a size of the account activity section 220 can be reduced. Then, a button can be selected that causes interface component 228 to expand and the size of the account activity section 220 can be expanded.

A number of selectable links can be located at the bottom of layout 200. In one embodiment, links to a privacy policy and terms and conditions are shown. A selection of the privacy policy link 234 can cause the system to display a privacy policy associated with the system. A selection of the terms and condition link 236 can cause the system to display terms and conditions that are associated with using the system.

Finally, a branding component 238 can be displayed in a lower left corner of the layout 200. In one embodiment, the branding component 238 can include a phrase associated with the system, such as “Send an ad. Get Paid™.” As noted above, with respect to the FIGS. 5A, 5B, 6, 7, 8, 9 and 10 further details of components of a dashboard interface for an interpersonal electronic advertising system are described.

### Presentation of Interpersonal Ads

In this section, details related to the presentation of interpersonal ads are described. In particular, FIG. 5A illustrates depictions of interpersonal ads including graphical and textual components sent by a user of the system that can be displayed in a dashboard interface and FIG. 5B illustrates depictions of interpersonal ads received by the user that can be displayed in a dashboard interface. As described above, the depictions of the interpersonal ads sent by the user or received from other users can be output one at a time or simultaneously to a user interface, such as the dashboard interface.

In FIG. 5A, depictions of six interpersonal ads, 240a-240f, sent by the user, “John Smith,” are shown. In one embodiment, each interpersonal ad depiction includes who sent the ad 244 (John Smith in the example), the operator 225 that enabled the interpersonal ad (TrustedAd™ in the example), an image representative of the product or service, a brief product description 246, a price 248, a selectable link 250 (“clicks for details” in the example) which when selected causes the system to display more information about the product and a selectable link 252 (“Click for purchase in the example) which when selected can direct the user to an interface that allows them to purchase the product identified in the ad. As examples, ad 240a includes a graphical depiction 242a of a blu-ray player, ad 240b includes a graphical depiction of a DVD player, ad 240c includes a graphical depiction 242c of a skin product (lotion), ad 240d includes a graphical depiction 242d of a computer desk, ad 240e includes a graphical depiction 242e of a jewelry piece (a necklace with a pendant) and ad 240f includes a graphical depiction 242f of a tire. In addition, branding components (not shown), such as a logo and a text phrase associated with the operator can be displayed on the ads (e.g., “Send an ad. Get paid.”). In one embodiment, branding components, such as a logo and text phrase can be displayed in a bottom right corner of the depiction of the ad. Other formats for depicting interpersonal ads can be utilized and the examples in FIGS. 5A and 5B are for purposes of illustration only.

In FIG. 5A, six interpersonal ads sent by the user are depicted simultaneously. In other embodiments, a maximum number of interpersonal ads that is greater or less than six can be displayed to a dashboard interface. In one embodiment, the system can be configured to accept user input that allows a number of interpersonal ads that are to be displayed simultaneously on the dashboard interface to be selected. One option can be not to display any interpersonal ads.

Depending on the number of interpersonal ads that are input, a format of the dashboard interface can be adjusted. For example, depending on the number of interpersonal ads which are input, a size of each interpersonal ad can be increased or decreased. Further, the space allocated to other components of the dashboard interface, such as the profile interface component or the referral interface component shown in FIG. 4, can be increased or decreased depending on how much space is allocated to the depiction of the interpersonal ads shown in FIG. 5A.

As described above, the space available to depict interpersonal ads can accommodate a number of interpersonal ads that is less than a total number of interpersonal ads that are available for output to the dashboard interface. In one embodiment, to allow a user to view the interpersonal ads that are not shown, the interface can include the arrow buttons, 216 and 230. A selection of button 216 can cause all or a portion of ad 240a to disappear from the interface and cause all or a portion of a new ad to be shown below ad 242. A selection of button 230 can cause all or a portion of ad 240f to disappear from the interface and can cause all or a portion of a new ad to appear above ad 240a. In another embodiment, a selection of button 216 can cause up to six interpersonal ads after ad 240f in a list of interpersonal ads to replace the interpersonal ads that are currently displayed and a selection of button 230 can cause up to six interpersonal ads preceding ad 240a in a list to replace the interpersonal ads that are currently displayed.

The use of buttons 216 and 230 is provided for the purposes of illustration only. An interface can be designed to accept a variety of inputs that allow the interpersonal ads to be changed or moved in the manner described in the previous paragraph. For instance, using a touch screen interface, an upward or downwards motion detected on the touch screen can cause the interpersonal ads to scroll upwards or downwards. In addition, an interface can allow a user to select one of the interpersonal ads that are depicted and drag it upwards or downwards to scroll the list upwards or downwards.

In FIG. 5A, the interpersonal ads are depicted as orientated vertically on top of one another and can be scrolled in the vertical direction. In alternate embodiments, the interpersonal ads can be rendered horizontally in a side by side manner. The interface can be configured to accept inputs that allow the interpersonal ads to move in a horizontal manner including moving all or a portion of an interpersonal ad currently displayed off the interface and moving all or a portion of an interpersonal ad currently not displayed onto the interface.

In FIG. 5B, six interpersonal ads, 256a-256f, that have been sent to the user associated with the dashboard interface described with respect to FIG. 4 are depicted. The format of the interpersonal ads that are received by the user and sent by the user is similar. One difference is that each of the received interpersonal ads identify the ad suggester that sent the interpersonal ad. For example, ads 258a-258f, are sent from Lisa Public, Jane Smith, John Smith, Tom Smith, Katie and Bill Dunn.

In this example, the user can be named John Smith. In some instances it is permissible for the user to send themselves an interpersonal ad. Thus, ad 256c may have been sent from John Smith to himself. Interpersonal ads 256b and 256d are sent from a smith. The smith's can be family members of the user. For instance, Jane can be his wife and Tom can be his son.

In various embodiments, an interpersonal ad can be sent with a first name and last name, a first name only, a last name only or even a nickname. For example, Katie, in ad 258e, can be a nickname or a first name of the ad suggester. When an interpersonal ad is generated, an interface for generating the interpersonal ad can be configured to allow a user to specify how their name or nick name is to appear on the interpersonal ad. For example, a user may be known to a first ad recipient by their nickname and thus, the system can be configured to allow a user to specify their nickname when sending interpersonal ads to the first person. However, a second person may not know the user by their nickname. In this instance, the system can be configured to allow a user to specify an alternative, such as their formal name.

### User Profile Interface Component

In this section, a user profile component 212 of the dashboard interface described in FIG. 4 is discussed in more detail. FIG. 6 illustrates an example of a user profile 212 that can be displayed in a dashboard interface in accordance with the preferred embodiments. The user profile 212 can include i) a user image 294, ii) a commissions paid 270 including its current value 282, iii) a commissions pending 272 including its value 274, iv) a potential commissions section 276 and its value 278, v) a global ad suggestion effectiveness metric 280, such as a global conversion rate, and its current value 283, vi) a status 284 including a current indicator 285, vii) a selectable button 279 that can cause the system to display additional account information.

The commissions paid 270 can be an amount of money earned from sending interpersonal ads. Commissions can be earned for purchases resulting from sent interpersonal ads and/or ad activations. In the example, commissions of $314.25 have been earned. In particular embodiments, the commissions can be displayed in different currency values. For instance, if a user lives and banks in the US, then the system can display the value of the commissions paid in US dollars.

The commissions pending 272 can be an amount of commissions that are pending. The value amount is $628.50 dollars. There can be a delay period from a time a commission is earned to a time when the user receives payment. The delay period can vary from merchant to merchant depending on when the merchant benefiting from a purchase via the system decides to pay. The system can be configured to track pending commissions and display their value 274.

The potential commissions 276 can be an amount of commissions related to ads that the user has created but have not yet lead to purchases. The value amount is $989.12 dollars. The system can be configured to commissions as ads are created and display their value 278.

The Ad Success, conversion rate, 280 is an example of ad suggestion effectiveness metric. In one embodiment, Ad Success 276 displays a value of a global conversion rate 278 which is a ratio of the total number of purchases to total number of interpersonal ads sent already by the user. In 278, a conversion rate of 27% is shown. This value can go up or down as the user sends out more interpersonal ads and ad recipients purchase using those interpersonal ads.

The status 284 can be related to an account status for the user. Status 284 can indicate whether the user can send new ads, is blocked from sending new ads (if they got caught spamming for example) or has reduced or limited ad sending abilities. Status 284 may also affect commissions. In one embodiment, users with higher conversion rates and a better status 284 can earn larger commissions than users with lower conversion rates for purchases of the same product. In 284, the status is identified as ‘Go,’ meaning that the user is free to create new ads.

A selectable button 279 can cause the system to display additional account information. In this case, selecting button 279 causes a lower section including account information 294 and commission destinations 286 to appear or roll open at the bottom of the profile at a glance box. Account information 296 lists personal information for the user 294. An edit button 288 permits a user to change one or more of the contents in account information 296. Commission destinations 297 lists all of the financial options for a user to elect as payment options for their successful ads. An edit button 299 permits a user to change one or more commission destinations 297.

### Ad Suggestion Related Data Interface Component

In this section, examples of ad suggestion related data that can be displayed interface components 222 and 224 of the dashboard interface are described with respect to FIG. 7. The ad suggestion related data help a user evaluate their performance within the interpersonal ad system. In interface component 224, the number of interpersonal ads sent 314 and the number of purchases 312 resulting from the interpersonal ads are shown. In this example, these values may be displayed because the conversion rate described in the previous section is determined from these quantities. If another type of ad suggestion effectiveness metric is utilized, then interface component 224 can display information related to the other type of ad suggestion effectiveness metric.

The number of interpersonal ads sent 314 is displayed on a circular gage 296. Other graphical formats can be used and a gage is but one example of a graphical format. A total number of purchases 316 are displayed in the center of the gage. In the example, fifty one purchases are displayed in the center. A portion 298 of the gage is shaded. The shaded portion 298 can provide a graphical representation of the number of interpersonal ads sent that are displayed in the center 316 of the gate 296.

The number of purchases is also represented on a circular gage 300. A portion 301 of the gage is highlighted to graphically represent the number of purchases. In one embodiment, a comparison of a size of the portion 301 and a size of portion 298 can provide a visual indicator of the conversion rate. When the portion sizes are about the same size, the conversion rate is close to 100%. When the portion size 301 is much smaller than the portion size 298, the conversion rate is close to 0%. The total number of purchases 312 is displayed in the center 310 of the gage 300. In this example, the total number of purchases is nine and the conversion rate, ratio of total number of purchases to total number of ads sent, is about 17%.

In section 222, the revenue that the user has earned is broken out in a monthly format 302. The revenue amount is plotted on a first axis 308 and the month is plotted on a second axis 306. The amount earned per month is represented as bars 304a-304f. In other embodiments, this information can be represented in other graphical formats. For example, a point on the graph can be used to represent a value amount for each month and line can connect each of the points.

The system can be configured to output other data associated with a user's ad activities. The interface can be configured to allow a user to select the data type and format to output. For instance, the user may be able to provide input that causes the interface to output purchases per time period (e.g., month) or interpersonal ads sent per time period (e.g., months) in section 222.

### Recent Ad Activity Interface Component

In this section an interface component 226 of the dashboard interface for outputting ticker messages and other information on a user's latest ad activity is described with respect to FIG. 8. In one embodiment, the recent ad activity component 226 can list interpersonal ads the user has previously sent in chronological order. As an example, interpersonal ads 240a-240f, described above with respect to FIG. 5A, are listed in the order in which they were sent. Interpersonal ads 240a and 240d have been sent to person “a.” Interpersonal ad 240a is the most recent interpersonal ad that has been sent. Interpersonal ads 240b and 240f have been sent to person “b.” Interpersonal ad 240c has been sent to person “c” and interpersonal ad 240d has been sent to person “d.”

An image associated ad recipient can be presented with each ad entry in the list. In one embodiment, the image may have been uploaded by the user that has sent the interpersonal ad. In another embodiment, when the ad recipient is also a user of the system, the image may have been uploaded by the ad recipient. The image can be an image of the ad recipient. However, the image can also be an avatar or another image, such as an image of the ad recipient's pet. The image can be selected to remind the user who is the recipient of the ad. In FIG. 8, images 318a-318d is associated with interpersonal ads, 240a to 240f, respectively. Images 318a and 318b are repeated because two interpersonal ads have been sent to person “a” and two interpersonal ads have been sent to person “b.”

Interface component 226 of the dashboard may also display ticker messages. The ticker messages may include account updates, service announcements such as the addition of new merchants, corrections to commissions, and other messages from the service provider to a user.

The message ticker 321 can also display recent information associated with the user account. The information can scroll through (e.g., like a ticker) or refresh periodically in the box to allow multiple messages to be displayed in a dynamic manner. In the example, message ticker 321 displays a ticker message the user has changed a commission destination for a pending ad. Other examples of messages that can be displayed can include messages related to interpersonal ads that the user has received, messages from the system to the user, ads from other users, and messages from other users.

As another example of system to user message, a message 321 can be sent from the system to the user that is displayed on the ticker when a commission is paid. In yet another example, a message 321 can be sent from the system to the user when there is account issue. An example of account issue can be if the user's conversion rate is approaching or has dropped below a threshold conversion rate at which point remedial action, such as placing a limit on a number of ads a user can send, is to be implemented. In an additional example, a message can be sent from the system to the user when the user's commission rank has changed. As an example of a user to user message, a second user can send the user a reminder related to a recently sent interpersonal ad where information associated with the reminder can be displayed in the user's message ticker 321.

In FIG. 8, the ticker messages 321 and messages for interpersonal ads sent to all ad recipients are displayed in chronological order. In other embodiments, the interface can be configured to accept user input parameters that filter and/or adjust an arrangement of the interpersonal ads and ticker messages. For instance, the user can input parameters that cause the interface to display ticker messages and interpersonal ads sent within a particular period. In another example, the user can input parameters that cause the interface to display interpersonal ads only sent to one individual, such as all ads sent to “Jane Smith,” or to display interpersonal ads only sent a group of individuals, such as their family, or not to display any ticker messages 321. In yet another example, the user can input parameters that cause the interface to display interpersonal ads grouped according to product category, such as ads related to travel or ads related to clothing.

The user can also input parameters that cause the interface to display multiple instances of the same interpersonal ad. For example, a user can send an interpersonal ad for the same product to multiple individuals and the interface can be configured to list all of the interpersonal ads sent to the multiple individuals for the same product. With respect to FIG. 10 below, a component of the interface for displaying ad status information for individual interpersonal ads is described. The interpersonal ads in FIG. 10 can also be grouped in the manners described above, such as in chronological order, per individual, per product category, etc.

The number of ticker messages and messages for interpersonal ads that can be displayed in the interface at one time can be less than the total number of ticker messages and messages for interpersonal ads available for display. Thus, some of the ticker messages and messages for interpersonal ads that have been sent may not be shown. To view the ticker messages and messages for interpersonal ads that are not shown navigation tools, such as the arrow buttons, 322 and 324, and the scroll boar 326, can be provided. The navigation tools may allow a user to navigate through a list of ticker messages and messages for interpersonal ads. For example, when the list is organized in a chronological order, the navigation tools can be used to move forward or backward in time through the list until an end of the list reached, i.e., the most recent or the oldest messages that are available on the list.

As described with respect to FIG. 5A, a rank value for each interpersonal ad in a group of interpersonal ads can be determined and a list can be ordered according to the determined rank value. Thus, in particular embodiments, two or more lists of interpersonal ads can be generated and output simultaneously to the dashboard interface where the lists are ordered using different criteria. For example, a first list can be generated from a group of interpersonal ads that is ordered chronologically and a second list can be generated for the same group (or different group) of interpersonal ads that is ordered according to rank value. The dashboard interface can be configured to output each of the first list and second list simultaneously. Further, the interface can be configured to allow a user to navigate through each of the first list and second list according to the order generated for each list respectively.

### Referral Interface Component

In this section, an interface component 228 associated with a referrals reward program is described with respect to FIG. 9. In a referrals reward program a user can invite an individual to participate the interpersonal electronic advertising system. For example, the invite can cause an invitation message to be sent to the individual. In response to receiving the invite, the invited individual can register with the system and then begin creating and sending interpersonal ads. Based upon activities of the invited individual, such as purchases resulting from the sent interpersonal ads, the invited individual and the user that sent the invite can both earn revenue. For example, the invited individual can earn commissions based upon the purchases whereas the invitee can earn revenues when objectives in the referrals reward program are met.

In FIG. 9, referral interface component is configured to display information related to the user's status in the referrals reward program including progress towards program objectives, objectives in program, rewards in the program, objectives met and a reward payment destination. Further, the interface component includes a button 340 that when activated causes an interface to be generated that allows the user to invite another individual to join the system. After identification and contact information is specified for the invitee, the system can send an invitation. The invitation can be in the form of an electronic message, such as a text or an e-mail.

One indication of a user's status in the rewards program can be the number of successfully invited users. In one embodiment, a circular gage 328 is generated to present the number of referrals (or invites) for the user. The total number of referrals 346 is displayed in a center of the gage 328. The gage can be configured to represent some maximum amount of referrals, such as 50. A portion of the gage 330 can be shaded to indicate how close the user is to a maximum amount. A shaded portion 330 representing twelve referrals is shown on the gage 328.

In one embodiment, objectives (not shown) can be marked on the gage 328. For instance, a user may have to successfully invite five or ten other individuals before rewards can be earned in the referral rewards program. This number (e.g., five) can be marked and identified on the gage as an objective. A message can be provided with the objective, such as “Invite five friends to begin earning rewards.” When the objective is reached, the system can be configured to stop displaying the message. In another example, the user can earn a reward for successfully referring fifty users. This objective can also be marked and identified on the gage 328.

In one embodiment, rewards in the referrals reward program can be based upon total commissions earned by the referrals indicated in 346. In particular embodiments, the total commissions can be determined from all or a portion of the referrals, such as a top ten referrals by revenue earned. As an example, circular gage 332 is used to indicate a total amount of commissions resulting from the interpersonal ads sent by the top ten referrals of the user. The total amount of commissions 348, $105 dollars in this example, is displayed in the center of the gage 332. The shaded portion 334 on gage 332 is used to graphically represent the total commissions amount 348 displayed in the center of gage.

The table 356 in the interface component 228 is used to convey objectives in the referrals rewards program. The table 356 includes the headers, commissions by top ten 336, bonus 338, status 342 and destination 344. The commissions by top five 336 is an example of an objective. The objective is based upon a total amount of commissions resulting from interpersonal ads sent by the user's top five referrals. Another objective (not shown) can be a number of interpersonal ads sent by the user's referrals resulting purchases. Yet another objective (not shown) can be a total value amount of the purchases resulting from the interpersonal ads sent by the referrals. Other objectives can be specified and shown in table 356. Thus, the example of commissions by top five 336 is described for the purposes of illustration only.

The bonus 338 is a reward that is provided to the user for meeting the objective. The status 342 can indicate that an objective has been met and whether the user has been credited with the reward associated the objective. The destination 344 can be a payment destination. The payment destination 344 can be an account controlled by the user or an account controlled by a third party, such as a charity.

In table 356, three objectives, 350, 352 and 354 are shown. The three objectives are $250, $1000 and $5,000 in total commissions resulting from interpersonal ads by the top 5 referrals. The bonus is ten percent of the total commissions. The bonus is not earned until the specified objective is reached. In another embodiment, the user can earn referral rewards on a transaction by transaction basis. For instance, the user can earn a reward that is a percentage, such as ten percent, on each commission earned by one of their referrals which can be paid on a purchase by purchase basis.

The total amount of rewards that is earned in the rewards program can be capped. For example, the user may be able to earn up to $3000 dollars in the rewards program after which the user will no longer earn rewards based upon their referrals commissions. In another example, a time period in which a user can earn rewards from referrals can be identified. For instance, the user may be able only to earn rewards from a particular referral for one year after the referral has joined the system.

In table 356, the status 342 of the first objective 350 is “paid.” The status indicates the user has met the objective of the rewards program and has been credited with the reward associated with meeting the objective, i.e., ten dollars in this instance. The statuses of the other two objectives, 352 and 354, are blank. A blank status can indicate that the objective has not been met or that the objective has been met but the system has not credited the user. In one embodiment, a secondary indicator, such as “earned” can be used in a status box to indicate a reward has been earned but not yet credited to the user.

The destination 344 of the first objective 350 is indicated as a “charity.” Thus, when the reward was paid, the $25 was given to the charity on behalf of the user. Prior to the reward being paid, the system may allow a selection of the destination box, such as the box including “charity.” After the selection, the user can select or input a new payment destination and the destination box can be updated to reflect the change in the payment destination. For example, a user can select charity and then designate self to have the payment sent to their account as opposed to the charity. The destination box to indicate the destination can be updated with the word “PayPal” or “bank.”

For the other two objectives 352 and 354, the destination boxes include the word, “add.” The “add” can be used to indicate that the system has not received a payment destination. The system can be configured to allow the user to select the boxes including the word add and then provide an interface that allows a user to select or input a payment destination. After the payment destination is specified, the payment box can be updated with an indicator to indicate that the payment destination, such as self, son, daughter, wife or charity. In another embodiment, the destination boxes do not include the word “add” until the user's invites reach the milestone, at which time the user may be prompted to add a payment destination.

### Ad Status Interface Component

In this section, an ad status interface component 232 of the dashboard interface is described with respect to FIG. 10. In one embodiment, the ad status interface component 232 can include information about each interpersonal ad sent by the user and information about the interpersonal ad status. For example, the information about each interpersonal ad can include but is not limited to a) the ad recipient 358, b) ad details 360, such as a name and a description of the product, c) a commission 364 that will be paid if a purchase results from the interpersonal ad, e) a payment destination 366 and f) a time 368 at which payment of a commission for a interpersonal ad that has guided a purchase. In addition, a number of status indicators 362 can be provided for each interpersonal ad.

In 232, status indicators 372, 374, 376 and 378, are generated. Status indicator 372 indicates the interpersonal ad has been sent. Status indicator 374 indicates a purchase has been guided by the interpersonal ad. Status indicator 376 indicates a payment is being processed for the purchase. The payment can be for the compensation 364 associated with the interpersonal ad. The status indicator 378 can indicate that a payment resulting from a purchase has been successfully credited to a payment destination.

In FIG. 10, interpersonal ad 240a for a blu-ray player was sent to person “a.” A purchase resulted from the interpersonal ad and compensation of $7.19 has been paid to a designated charity. Interpersonal ad 240b for a DVD player was sent to person “b.” A purchase has not been made, but, compensation of $8.01 is to be credited to the user if a purchase is subsequently made. Interpersonal ad 240c for a hand lotion has been sent to person “c.” A purchase has been guided by the ad and compensation of twenty-seven cents is being processed. It is estimated that a payment will be sent to a charity in about one week.

Interpersonal ad 240d for a desk has been sent to person “a.” A purchase has not been made, but, compensation of $14.99 is to be credited to the user's daughter if a purchase is guided from the interpersonal ad. Interpersonal ad 240e for a necklace has been sent to person “d.” A purchase has not been made, but, compensation of $9.03 is to be credited to the user if a purchase is guided by the interpersonal ad. Finally, interpersonal ad 240f for tires has been sent to person “b.” A purchase has been made, but, processing of the payment has not begun. Compensation of $11.82 is to be sent to a charity upon payment.

In FIG. 10, the interpersonal ads 240a-240f are arranged in a chronological order where interpersonal ad 240a, which has been sent more recently, is at the top of the list. A number of different ways in which the interpersonal ads can be arranged are described above with respect to FIG. 8. In addition, the interpersonal ads can be grouped according to their status indicators in 362. For example, all sent interpersonal ads that have resulted in purchases where the purchases have been paid can be grouped together. Within the group, the interpersonal ads can be listed in chronological order, from highest to lowest price or lowest to highest price.

As another example, all sent interpersonal ads where payment for a purchase is being processed can be grouped together. In yet another example, all sent interpersonal ads from which a purchase has been made but processing has not begun can be grouped together. In a further example, all sent interpersonal ads for which a purchase has been made but payment hasn't been made (e.g., 240c and 240f) can be grouped together. Finally, all of the interpersonal ads that have been sent, but from which a purchase has not been guided, (e.g., 240b, 240d and 240e) can be grouped together.

Other groupings based on other status indicators are possible and the examples described in the previous paragraph are for the purposes of illustration only. For example, one status indicator (not shown) can be whether the ad has been clicked or viewed in some manner and how many times the ad has been clicked prior to a purchase. In FIG. 10, this indicator might be interposed between the ad sent indicator 372 and the purchase made indicator 374.

In further embodiments, the interpersonal ads can be grouped according to their payment destination. For instance, all interpersonal ads where the payment destination is a charity can be grouped together. Further, the interpersonal ad can be grouped and/or arranged according to a potential compensation value. For example, the interpersonal ads arranged from highest to lowest or lowest to highest compensation values. As another example, the interpersonal ads with a compensation values between zero and ten dollars can be grouped together, interpersonal ads with a compensation values between ten and one hundred dollars can be grouped together and interpersonal ads with a compensation values above one hundred dollars can be grouped together. Within a group, the interpersonal ad can be arranged according to their individual compensation value. For example, the interpersonal ad with the highest compensation value in the group can be listed first and the interpersonal ad with the next highest compensation value can be listed below it.

In yet other embodiments, the interpersonal ads can be grouped according to an ad suggester metric value between the ad suggester and the ad recipient. For example, interpersonal ads sent to individuals where a conversion rate between the ad suggester and the ad recipient is above 50% or equal to 50% can be grouped together and interpersonal ads sent to individuals where a conversion rate between the ad suggester and the ad recipient is below 50% can be grouped together. Within the group, the interpersonal ads can be arranged according to commission value, chronologically, according to the conversion rate between the ad suggester and the ad recipient, etc.

As described above, the number of interpersonal ads that can be displayed in the interface component 232 at one time can be less than the total number of interpersonal ads that have been sent. Thus, some of the interpersonal ads that have been sent may not be shown. To view the interpersonal ads that are not shown navigation tools, such as the arrow buttons and the scroll bar 370, can be provided. The navigation tools may allow a user to navigate through a list of interpersonal ads. For example, when the list is organized in a chronological order, the navigation tools can be used to move forward or backward in time through the list until an end of the list reached, i.e., the most recent ad sent or the oldest ad sent that is available on the list.

Methods Associated with a Dashboard Interface

In this section methods of generating a dashboard interface are described. FIG. 11 is a flow chart of a method 400 of generating an interface that allows a user to monitor their activities within the interpersonal electronic advertising system in accordance with the preferred embodiments. In 402, an individual can register as a user with the interpersonal electronic advertising system. In 404, the system can receive selections and inputs from the user that allow a plurality of interpersonal ads to be created and sent to ad recipients.

In 406, the system can receive dashboard interface configuration setting. The configuration setting can affect a format of the dashboard interface. For example, a number or a size of interpersonal ads that are displayed at one time in a portion of the display (e.g., see FIGS. 5A and 5B) can be specified. As another example, whether to group interpersonal ads according to an ad status indicator, such as sent, purchase, processing or paid, according to a conversion rate between the ad suggester and ad recipient or according to compensation value, as described above with respect to FIG. 10, can be specified. Further, as a configuration setting, the user can specify whether to have certain interface components rendered or not rendered in the dashboard interface. For example, the system can be configured to allow the user to specify whether to display the referral section (see FIG. 9) in the dashboard interface.

In 408, a request to output a dashboard interface for the user can be received by the system. In one embodiment, a link to the dashboard interface can be provided on a home page of an interpersonal electronic advertising system after a user has successfully logged into the system. A selection of the link can cause the system to generate and output the dashboard interface. In another embodiment, the dashboard interface can be automatically generated when a user successfully logs into the system.

In 410, the system can retrieve dashboard interface data that allows the dashboard interface to be generated as described above with respect to FIGS. 4-10. For example, the dashboard interface data might include but is not limited to a) a list of interpersonal ads to display in the interface and data needed to generate the interpersonal ads in the interface, such as images and details of products (see FIGS. 5A and 5B), b) user profile data, such as a conversion rate or a commission rank (see FIG. 6), c) statistical data related to the user's activities on the system, such as data associated that allows revenue per month, total interpersonal ads sent and a total number of purchase from interpersonal ads to be determined (see FIG. 7), d) a list of interpersonal ads sent by the user and details of the interpersonal ads arranged in a chronological order (see FIG. 8), e) data associated with a referrals reward program (see FIG. 9) and f) ad status data, such as whether a payment has been received for a interpersonal ad and a commission associated with an interpersonal ad (see FIG. 10.)

In 412, current values of dashboard parameters that are to be output can be determined, such as a current conversion rate that is to be displayed in the user profile interface component. In 414, the system can control output of the dashboard interface using the current values of the dashboard output parameters. In 416, the system can receive dashboard control inputs that affect the display of the dashboard interface. For example, the user can provide input that causes the interface to scroll through a list of interpersonal ads or the user can provide input that causes a list of interpersonal ads to be grouped in a different manner. In response to receiving the inputs, the method can return to step 410. The method can end when the user logs off the system, the system logs the user out or the user navigates away from the dashboard interface page.

### Network and Devices

FIG. 12 illustrates a diagram of a sample network 241 in which systems and methods consistent with the principles of the embodiments described herein may be implemented. Network 241 includes one or more clients 243 connected to one or more servers 245-247 via a network 249. Two clients 243 and two servers 245-247 have been illustrated as connected to network 249 for simplicity. In practice, there may be more or fewer clients and servers. Also, in some instances, a client performs a function of a server and a server performs a function of a client.

Clients 243 can be electronic devices, such as a personal computer, a wireless telephone, a personal digital assistant (PDA), a laptop computer, a mobile device, an mp3 player, a tablet, a television, a thin client, or any other type of computation of communication device, a thread or process running on one of these devices, or an object executable by one of these devices. One or more users (e.g., an ad suggester 4 or recipient 8) are associated with each client 243. Servers 245 and 247 include server entities that access, fetch, aggregate, process, search or maintain data in a manner consistent with the principals of the disclosure. Clients 243 and servers 245 and 247 connect to network 249 via at least one network interface that may include one or more wired, wireless, cellular or optical connections, or any other type of connection. The network interface relays communications to network 249. In one embodiment, clients 243 or servers 245 and 247 include a network interface dedicated to receiving input and a second network interface dedicated to send data to the network 249. In a specific embodiment, clients 243 or servers 245 and 247 includes a single network interface that both receives and sends data via the network 249.

In one embodiment, server 245 includes an advertisement system 251 useable by users at clients 243. Server 245 may implement an advertisement platform with advertisements from one or more vendors and sources, index the ads and store information associated with the ad data in a storage device. In some embodiments, server 245 hosts advertisements that are provided to users at clients 243. In one embodiment, ad system 251 provides an advertisement creation interface to clients 243. Via the interface, the ad system can provides a listing of ads that an add suggester can select. The system can be configured to receive electronic advertisement input. In some embodiments, the electronic advertisement input can be used in a search feature associated with the interface. The search feature can be used to locate particular ads that a user may wish to suggest. After ads are selected, ad system 251 can be configured to execute an advertisement provision function that allows an interpersonal ad to be sent an ad recipient. The ad recipient can access the interpersonal ads via one of the client devices.

Server 247 stores or maintains data that may be crawled by server 245. In one embodiment, the server 245 can store ad related data. Such data may include information described above for data storage 30.

Network 249 includes one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The telephone network may further include 3G, 4G, or Mobile WiMAX, Long Term Evolution (LTE). The PLMN(s) may further include a packet-switched sub-network, such as, for example, General Packet Radio Service (GPRS), Cellular Digital Packet Data (CDPD), or Mobile IP sub-network.

While servers 245 and 247 are shown as separate entities, it may be possible for one of servers 245 or 247 to perform one or more of the functions of the other one of servers 245 or 247. For example, servers 245 and 247 may be implemented as a single server. It may also be possible for a single one of servers 245 or 247 to be implemented as two or more separate (and possibly distributed) devices. In addition, in some embodiments, one or more functions attributed to the servers 245 and 247 in the description provided herein can also be implemented on one of the clients or vice versa.

FIG. 13 illustrates a sample computing system 261, which may correspond to one or more of clients 243 and/or servers 245-247. Computer system 261 comprises a processor, or CPU, 263, input device 265, output device 267, communication interface 269, system bus 271, one or more main memory 273, ROM 275, BIOS 277, and storage device 279. System bus 271 permits digital communication between system processor 263 and ROM 275, as well as permits communication between other components within system 261 and processor 263 and/or ROM 275.

Processor 263 is a commercially available microprocessor such as one of the Intel or AMD family of chips, or another suitable commercially available processor. Processor 263 digitally communicates with ROM 275 via system bus 271, which may comprise a data bus, control bus, and address bus for communication between processor 263 and memory 273. CPU 263 is also coupled to the communication interface 269 by system bus 271 to permit data transfers to and from computing system 261.

System memory can include read only memory (ROM), such as 275. Other memories may be included or substituted for ROM 275, such as random access memory (RAM) 273. Computer system 261 may also include a storage device 279, such as a hard disk drive or an optical disk drive, for example. The drives and their associated computer-readable media provide non-volatile storage for system 261. A number of program modules are stored in the drives, ROM 275, and/or RAM, including an operating system, one or more application programs, other program modules, and program data. Although data storage above refers to a hard disk and optical disk, those skilled in the art will appreciate that other types of storage are suitable for use with a computer system, such as magnetic cassettes, flash memory cards, USB memory sticks, and the like. In addition, not all computer systems, such as PDAs and other portable devices include multiple external memory options.

Communication interface 269 provides an interface between CPU 263 and such peripheral devices as a display device, input device 265, output 267, network interface, and/or any other I/O device. For example, a mouse used as input device 265 digitally communicates with processor 263 through a serial port 269 that is coupled to system bus 271. Other interfaces, such as a game port, a universal serial bus (USB) or fire wire, may also provide digital communication between a peripheral device and processor 263. Output 267 may comprise one or more speakers employed by a headphone or speaker system. Input device 265 allows a user to enter commands and information into the computer system 261, and may comprise a keyboard, a mouse, a position-sensing pad on a laptop computer, a stylus working in cooperation with a position-sensing display on a PDA, a touch screen system, a microphone, a touch sensitive device or the like.

In addition to personal computers such as desktop computers and laptop computers, a variety of other computer systems and computer devices employing a digital processor, memory and a display device may implement techniques described herein. Handheld computers and other small portable digital devices such as cell phones and digital cameras are increasingly integrating video display and computer functionality. One current trend is hybrid entertainment devices that integrate the functionality of computer systems, phones, and gaming systems. Any of these devices may implement the advertising methods and compensation systems described herein. The scope of digital computer systems is expanding hurriedly and creating new devices suitable for use herein.

Embodiments of the present invention further relate to computer readable media that include executable program instructions for performing interpersonal advertisement techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

Interpersonal advertising and compensation system software and interfaces such as those described herein may be implemented using a number of computer languages and in a number of programming environments. One suitable language is Java, available from Sun Microsystems of Sunnyvale, Calif. Another suitable programming environment is the Microsoft Windows™ programming environment, which provides a series of operating systems suitable for implementing the present invention both on laptop computers and handheld computers. C or C++ are also suitable for use herein.

Although the foregoing invention has been described in some detail for purposes of clarity of understanding, those skilled in the art will recognize that various modifications may be made within the scope of the appended claims. In addition, although advertising has not been detailed for every type of electronic device, the present invention is suitable with any technology that provides electronic advertisements. The invention is, therefore, not limited to the specific features and embodiments described herein and claimed in any of its forms or modifications within the scope of the appended claims.

1. A method in an interpersonal electronic advertising system, the method comprising:
generating in a processor a user account associated with a user;
generating in the processor a plurality of interpersonal ads associated with the user account using contents and one or more ad recipients input by the user;
receiving in the processor a request to generate a dashboard interface associated with the user account;
in response to the request, retrieving in the processor information associated with each of the plurality of interpersonal ads;
determining in the processor a purchase is associated with at least one of the plurality of interpersonal ads;
generating in the processor a state of the dashboard interface using the retrieved information wherein the state is configured to graphically output first information, second information, third information and fourth information associated with each of the plurality of interpersonal ads, said first information indicating an ad recipient of an interpersonal ad, said second information describing the interpersonal ad, said third information indicating whether the interpersonal ad is sent and said fourth information indicating whether the purchase is associated with the interpersonal ad and wherein the state is configured to graphically output fifth information associated with the at least one of the plurality of interpersonal ads, said fifth information indicating an estimated amount of time before compensation is attributed from the purchase; and
outputting the state to a display device associated with the user.

2. The method of claim 1, further comprising:
determining a number of the plurality of interpersonal ads that have guided purchases and outputting via the dashboard interface a ratio of the number that have guided purchases to a total number of plurality of interpersonal ads.

3. The method of claim 2, further comprising:
outputting via the dashboard interface the number that have guided purchases and the total number.

4. The method of claim 2, further comprising:
determining a status of the user based upon the number that have guided purchases and the total number and outputting via the dashboard interface an indicator of a commission rank.

5. The method of claim 4, further comprising:
determining at a first time a first status of the user and
determining at a second time a second status for of the user wherein a compensation rate associated with the first status is different than a compensation rate associated with the second status.

6. The method of claim 1, further comprising:
receiving an upload of an image from the user and outputting via the dashboard interface the image.

7. The method of claim 1, further comprising:
generating a graphical representation of at least one of the plurality of interpersonal ads wherein the graphical representation includes a name of the user and
outputting the graphical representation via the dashboard interface.

8. The method of claim 7, wherein the graphical representation includes an image of the user.

9. The method of claim 7, wherein the graphical representation includes a product description and a price.

10. The method of claim 7, wherein the name is a nickname.

11. The method of claim 1, further comprising:
determining an order of the plurality of interpersonal ads and
generating the state of the dashboard interface to include only a first portion of the plurality of interpersonal ads according to the determined order.

12. The method of claim 11, further comprising:
receiving an input via the state of the dashboard interface
in response to the input, regenerating the state of the dashboard interface to include only a second portion of the plurality of interpersonal ads according to the determined order.

13. The method of claim 11, wherein the order is a chronological order based upon when each of the first portion of the plurality of interpersonal ads was sent to the ad recipient.

14. The method of claim 1, further comprising generating the state of the dashboard interface to further include one or more of an image of the ad recipient, a product name, a product description, a product price or combinations thereof, associated with each of the plurality of interpersonal ads.

15. The method of claim 1, further comprising:
receiving a group of interpersonal ads sent to the user from one or more other users of the system and
generating the state of the dashboard interface to further include information associated with each of the interpersonal ads in the group.

16. The method of claim 15, further comprising:
generating a graphical representation associated with each of the interpersonal ads in the group wherein the graphical representation includes a name of an ad suggester that sent the interpersonal ad to the user.

17. The method of claim 15, further comprising:
determining a rank value associated with each of the interpersonal ads in the group,
ordering the interpersonal ads according to their rank value and
generating the state of dashboard interface to display the interpersonal ads in accordance with the order.

18. The method of claim 1, further comprising:
determining an ad status associated with each of the plurality of interpersonal ads and generating a graphical representation of the ad status of each of the plurality of interpersonal ads in the state of the dashboard interface.

19. The method of claim 18, wherein the ad status indicates one or more of a) whether the interpersonal ad has been sent, b) whether the interpersonal ad has been clicked, c) whether a purchase has been guided from the interpersonal ad, d) whether compensation associated with the interpersonal ad is being processed, e) whether the compensation associated with interpersonal ad has been paid or f) combinations thereof.

20. The method of claim 18, further comprising:
generating the state to include the ad status and one or more of a) the ad recipient of the interpersonal ad, b) compensation for associated with the interpersonal ad, c) details of a product associated with the interpersonal ad, d) a payment destination associated with the interpersonal ad, e) a time at which the compensation is expected for a purchase guided from the interpersonal ad; or f) combinations thereof.

21. The method of claim 1, further comprising:
determining a total amount of commissions earned by the user and
outputting the total amount via the dashboard interface.

22. The method of claim 1, further comprising:
determining a total amount of commissions owed to the user and
outputting the total amount via the dashboard interface.

23. The method of claim 1, further comprising:
outputting via the dashboard interface objectives in a trusted referral rewards program and rewards associated with the objectives.

24. The method of claim 23, further comprising:
outputting via the dashboard interface an indicator of the user's progress towards earning a reward in the trusted referral rewards program.

25. The method of claim 23, further comprising:
outputting via the dashboard interface a number of referrals by the user in the referrals reward program.

26. The method of claim 23, further comprising:
receiving a payment destination associated with a first reward and
outputting via the dashboard interface the payment destination associated with the first reward.

27. The method of claim 1, further comprising:
receiving a payment destination associated with one of the plurality of interpersonal ads and
outputting via the dashboard interface the payment destination.

28. A non-transitory computer readable storage medium including instructions for a processor in an interpersonal electronic advertising system, the computer-readable storage medium comprising:
computer code to generate a user account associated with a user;
computer code to generate a plurality of interpersonal ads associated with the user account using contents and one or more ad recipients input by the user;
computer code to receive a request to generate a dashboard interface associated with the user account;
computer code to in response to the request, retrieve information associated with each of the plurality of interpersonal ads;
computer code to determine a purchase is associated with at least one of the plurality of interpersonal ads;
computer code to generate a state of the dashboard interface using the retrieved information wherein the state is configured to graphically output first information, second information, third information and fourth information associated with each of the plurality of interpersonal ads, said first information indicating an ad recipient of an interpersonal ad, said second information describing the interpersonal ad, said third information indicating whether the interpersonal ad is sent and said fourth information indicating whether the purchase is associated with the interpersonal ad and wherein the state is configured to graphically output fifth information associated with the at least one of the plurality of interpersonal ads, said fifth information indicating an estimated amount of time before compensation is attributed from the purchase; and
computer code to output the state to a display device associated with the user.
